(19) United States
(12) Patent Application Publication
(10) Pub. No.: US 2025/0214385 A1
(43) Pub. Date: Jul. 3, 2025

(54) RAIL VEHICLE, IN PARTICULAR ROAD-RAIL VEHICLE, WHICH IS DESIGNED TO CHANGE TRACKS, AND CORRESPONDING SYSTEM AND METHOD

(71) Applicant: NT INNOVATION OHG, Pullach (DE)

(72) Inventor: Mathias Entenmann, Pullach (DE)

(21) Appl. No.: 18/839,647

(22) PCT Filed: Feb. 15, 2023
(86) PCT No.: PCT/EP2023/053798

§ 371 Date: Aug. 19, 2024

(30) Foreign Application Priority Data
Feb. 17, 2022 (DE) 10 2022 201 683.1
Feb. 17, 2022 (DE) 10 2022 201 685.8
Apr. 29, 2022 (DE) 10 2022 110 582.2
Nov. 15, 2022 (DE) 10 2022 130 200.8

(51) Int. Cl. B60F 1/00; B61L 25/02

(52) U.S. Cl. CPC B60F 1/005; B61L 25/026

(57) ABSTRACT

A method for operating a rail vehicle on track/rail/line guides for the purpose of an automatic track change and a system including at least one rail vehicle and at least one first and second track/rail/line guide. The rail vehicle includes a chassis and designed for a track/rail/line guiding process and on which at least two axles with two respective wheels are mounted, and comprising multiple track guide units, which can be coupled to the track/rail/line guide individually in a mechanical and/or magnetic manner independently of one another via at least one drive and/or actuator of the rail vehicle. The individual track guide units can be moved and/or activated independently of one another such that the rail vehicle can be decoupled from a first track/rail/line guide during a drive in order to change tracks and can be coupled to a second track/rail/line guide.

### TECHNICAL AREA

The present invention relates to a rail vehicle, in particular a road-rail vehicle with a chassis equipped for track/rail/track guidance, on which at least two axles are each mounted with wheels which can be individually coupled to the track/rail/track guidance independently of one another. Furthermore, the present invention also relates to a method for operating a rail vehicle, in particular a road-rail vehicle on track/rail/track guides, for the purpose of independent track changing. Furthermore, the present invention relates to a system comprising at least one rail vehicle and at least one first and second track/rail/track guide, wherein the rail vehicle can be decoupled from the first track/rail/track guide and can be coupled to the second track/rail/track guide.

### BACKGROUND OF THE INVENTION

Some vehicles should be suitable for different surfaces, for example for both asphalt (or road) and rail/rail tracks. Two-way vehicles that can drive not only in predefined lanes, e.g. on rails/tracks, but also on roads, are, however, usually bound to a/the lane that is predefined by the rail guidance, including the setting of points, when laning in or after laning in (predefined dependency, especially for rail/track guidance).

Utility model DE 20 2017 103 154 U1 describes a road-rail vehicle with track guidance units and wheels that exhibits advantageous behaviour, particularly when the track guidance units are being tracked in.

Based on the state of the art, there is further interest or further need for greater flexibility/variability in connection with the most flexible possible guidance of a rail vehicle, in particular a road-rail vehicle, in particular in the area of switches or other junctions of track/rail/track guides and directions, in particular for the purpose of decoupling/coupling the vehicle from or to a specific track/rail. In other words: The flexibility/variability of vehicles that have to be guided in a track-bound manner, particularly depending on the situation, is to be improved and the travelling of a vehicle in the rail system in all possible directions of travel is to be made possible regardless of the setting of the points.

### SUMMARY OF THE INVENTION

The task is to provide a rail vehicle, in particular a road-rail vehicle, or a corresponding system and a method for coupling and decoupling track-bound rail vehicles, in particular road-rail vehicles, with/from at least one track (in particular rail), whereby the greatest possible flexibility or high variability can be ensured with regard to the type and manner of track-bound guidance of the rail vehicle, in particular road-rail vehicle, in particular with regard to the direction of travel or routing. In particular, the task is to enable a rail vehicle, in particular a road-rail vehicle, to change lanes even in a rail system in such a way that the vehicle can decouple itself from a lane or rail and couple to another lane, in particular in the area of a switch (position) for rail/track guidance, in particular during a journey, preferably at a speed of the vehicle of over 10 km/h, whereby the lane change can be carried out during the journey by means of a control/regulation unit based on measured values from a sensor system of the rail vehicle.

This task is solved by a rail vehicle, in particular a road-rail vehicle according to claim 1 and by a method according to the respective secondary method/use claim. Advantageous further embodiments of the invention are explained in the respective subclaims and in system claims. The features of the embodiments described below can be combined with one another, unless this is explicitly negated.

Such a vehicle has the advantage that the vehicle does not necessarily have to follow the direction of travel specified by the switch position; for example, in the case of rail vehicles/vehicles travelling in quick succession, it does not have to follow the track currently specified by a/the respective predefined switch position (in particular also in order to be able to release the direction of travel, for example for a high-speed train, to overtake/pass a slower or stopping train or to avoid having to adjust a switch). Although a/the corresponding points could be changed for a short time, this is not possible or not desired in some situations, or this would possibly also entail risks with regard to the intended routing; in any case, depending on the size of the rail system and the vehicles involved, a correspondingly high level of communication or control/regulation technology would be required to enable unscheduled points to be set with a good level of safety.

According to the invention, a technology is provided which makes it possible to decouple vehicles, in particular road-rail vehicles, more easily from a single predefined track guide (in particular track/rail guide), in particular during a journey, and to couple them to another track guide (in particular track/rail guide) as required.

According to the invention, a rail vehicle is provided, in particular a road-rail vehicle with a chassis equipped for track/rail/track guidance, on which at least two axles are each mounted with wheels, and with a plurality of track guidance units which can be individually coupled to the track/rail/track guidance independently of one another via at least one drive and/or actuator of the rail vehicle.

According to the invention, it is proposed that the individual track guidance units can be individually displaced and/or activated, in particular during a journey, preferably at a minimum speed of 10 km/h, such that the rail vehicle can be decoupled from a first track/rail/track guide and coupled to a second track/rail/track guide for a track change in the area of a switch along the track/rail/track guide, wherein the track change can be carried out by means of a control/regulation unit based on measured values from a sensor system of the rail vehicle.

This track-bound but track-independent vehicle also provides a high degree of flexibility and independence from rail systems as such, particularly when using rail vehicles, especially road-rail vehicles, which usually also have to be used unscheduled (or according to a separate timetable that deviates from a first timetable and takes the first timetable into account).

The vehicle, a driver and/or a control unit can independently decide and specify which lane/track to follow.

The control component can control the track guidance units of at least some of the vehicles, in particular during a journey, preferably at a minimum speed of 10 km/h, in such a way that the track guidance units can be individually activated and/or displaced independently of each other in such a way that the vehicle can be decoupled from a first track/rail/track guide for a lane change and coupled to a second track/rail/track guide, in particular in the area of a switch along the track/rail/track guide. This makes it possible to select, variably maintain and, if necessary, change the direction of travel of vehicles independently of the points.

It has been shown that the ability to change track automatically or autonomously enables great flexibility/variability with regard to the use of the vehicle on the one hand and the use of the rail/track guidance or track(s) on the other, in particular largely independent of the current system status of the rail system (in particular independent of current points settings). The use of such rail vehicles, especially two-way vehicles, can also be very interesting for a rail network operator, e.g. if control interventions in the usual operating sequence are to be avoided and at the same time the utilisation/usage of the rail network is to be increased.

In contrast to previously tested technologies, the vehicle no longer has to stop for an uncoupling/coupling process and be lifted out of the lane, e.g. by a crane or similar non-system aid, or be moved a long way to a potentially usable exit point in order to be able to release or change lanes. The vehicle can also change lane while travelling, in particular at a minimum speed of 10 km/h, directly in the area of a switch without having to change the switch.

In the following, the road-rail vehicle is also generally referred to as a “vehicle”. In this respect, the chassis and the wheels can also be optimised for specific application-specific surfaces and tracks/rails, for example the wheels for a road or also for a special rail system. The invention can be implemented largely independently of the number of axles and the number of wheels, i.e. in principle also for single-axle vehicles or even for vehicles with only one wheel. Of course, vehicles are preferably equipped with at least two axles and at least four wheels, but the present invention can also be/is implemented for vehicles with fewer or more axles/wheels. Insofar as the present invention is/is implemented for rail vehicles, in particular road-rail vehicles, the wheels are preferably designed/provided for roads or asphalt, and in the case of a track coupling, the vehicle is preferably guided solely/exclusively by means of the track guidance units.

The functionality of the vehicle can optionally be based on the fact that the wheels can propel the vehicle both on the ground without tracks (off-track state) and on rails or similar tracks (on-track state).

The term “track” or “rail” (in each case in the singular) is to be understood here in the broader sense as a track or rail guide for vehicles with at least two wheels/guide units on the right and left (starboard and port) on a corresponding axle of the vehicle, so that the term “track” or “rail” can also refer to two parallel track guides or two parallel rail tracks. The singular also seems to be more appropriate here than the plural in that there may be vehicles that can be supported on only one track/rail (unlike a classic railway carriage, for example), e.g. with a comparatively wide support, such as maintenance vehicles for track/rail systems. The wording in the claims should also be understood in this sense: the arrangement described for one side of the respective axle can also be realised mirror-symmetrically on the other side of the axle in the case of two tracks/rail lines, but does not necessarily have to be, e.g. if a vehicle is present which can already rest on only one support or one wheel (tends to be the case with at least two axles arranged one behind the other). However, it is also known from the field of pedestrian/passenger transport systems, for example, that it is also possible to ensure that the vehicle is supported on just one wheel with sufficient stability (in particular with the aid of gyroscopes and actuators or servomotors relating to the spatial orientation of the vehicle). In this respect, the skilled person is free to choose the number of axles and the number of support points per axle.

The term “track” is understood as a generic term for all types of predetermined track guidance, and can therefore in particular also include the terms “rail guidance” and “track guidance” (whereby the term “track” is to be understood here in particular also in the narrower sense specifically as a reference to tracks for classic railway logistics). The concept according to the invention can be applied generally to track-bound vehicles and is explained here in particular with reference to rail guides for rail vehicles, in particular road-rail vehicles. Unless explicitly negated, in the context of the respective disclosure relating to “track” or “rail” or “track”, each of these three types of guides may be designated with equal priority; this applies here both to the wording of the claim and to the description.

The term “on the bow side” refers in particular to a position at the front/in front in the direction of travel. For vehicles that can also manoeuvre backwards, the direction can be the opposite. The term “bow side” can therefore also be generally understood to mean “front/front”, and the term “rear side” can therefore also be generally understood to mean “rear/rear”. In any case, “bow side” or “rear side” means a direction in or against the direction of travel, i.e. orthogonal to the lateral/transverse direction.

The term or verb “to couple” is generally understood as a generic term in the sense of “to guide” or “to fix with regard to a lateral transverse direction”. Unless expressly formulated otherwise, the general term “coupling” means both mechanical coupling and magnetic coupling as well as the combination of both types of coupling. In particular, this term should be understood to mean both “mechanical contact”, “bringing into engagement” or “bringing into form-fit contact” and “magnetic coupling”, depending on the design of the type of contact between the track guidance unit and track/rail/track. For mechanical coupling, a positive fit can be achieved by a rim or collar on at least one side, which is secured to the track guide unit of the corresponding rail, or by a wheel resting on the rail from above. For magnetic coupling, the magnetic field lines emanating from magnets and/or electromagnets located in track guide units form preferentially in the soft magnetic tracks/rails/rails in a coupled state due to the difference in permeability between air and the track/rails/rails, so that there is an attraction between track guide units and tracks/rails/rails. In the following, the term “coupling” will continue to be used in general and the special features and advantages of magnetic coupling will be discussed in more detail. Mechanical/magnetic coupling of track guidance units does not exclude the other type of coupling as an additional coupling, unless this is explicitly stated. This means that a mechanically couplable track guidance unit can also be magnetically coupled, but does not necessarily have to be, and vice versa.

The vertical displacement of the respective track guidance unit can also be described as a retraction (upwards) or extension (downwards).

The present invention is described in particular by reference to a vehicle with two axles and four track guidance units. Optionally, more than two track guidance units can also be provided per side, in particular four track guidance units, for example two track guidance units per wheel, which are arranged at the front and rear of an axle, or eight track guidance units, for example four track guidance units per wheel, including two track guidance units coupled to the inside of the rail (arranged at the front and rear of an axle) and two track guidance units coupled to the outside of the rail (also arranged at the front and rear). However, any number of track guidance units is also possible. For reasons of perspective, not all track guide units are always recognisable/shown in these figures.

The track guide units can optionally be arranged on the inside or outside relative to the respective track and can also optionally be displaced in a lateral direction. Such a redundancy of track guidance units can also simplify the possible uses of the vehicle with regard to different designs of the track beds or rails and points.

For travelling on the track/rail (straight-ahead travel), either a subset or all of the track guidance units can be coupled to the rail. Depending on the vehicle type and surface, and in particular also depending on whether a drive movement is to be transmitted (optionally via wheels or also via the track guidance units), a preferred number of track guidance units can be coupled in each individual case (in particular taking into account stability/locking and friction losses/rolling resistance). When travelling on the track/rail along a curve, the number of track guide units coupled to the track/rail can be greater on the inside of the curve than on the outside of the curve and/or the track guide units can be magnetically coupled more strongly to the track/rail on the inside (radially inwards) of the curve in order to prevent slipping off the track/rail/track guide.

Track guide units that are to be mechanically coupled can, for example, be designed as a roller with an at least approximately vertical axle (especially if the vehicle is not to be supported on the track via the track guide units), or as a type of miniaturised rail/railway wheel (which is particularly advantageous with regard to supporting large weight forces), or, for example, as a roller with a slightly inclined axle in relation to the horizontal plane for engaging with an underside of the rail profile. It is also possible to combine the above-mentioned features, both by using different designs for several track guide units and by combining a vertical axle and/or a miniaturised rail wheel and/or a roller for engaging the underside of the rail system in a single track guide unit. Track guide units that are to be magnetically coupled have, for example, a permanent magnet and/or an electromagnet connected to an actuator. The track guide units can be moved as required until the distance between the magnet and the rail is sufficiently small and the force effect sufficiently large. The permanent magnets can also be switchable and connected to an/the actuator. It is also possible to combine mechanical and magnetic coupling. For this purpose, magnets (permanent magnets and/or electromagnets) can be integrated into the track guide units, and rollers can also be connected to the track guide unit as a kind of miniaturised rail/railway wheel, optionally with a wheel rim, for resting on the track/rail/track guide, whereby the rollers can both act as spacers and support the hold on the track/rail/track guide.

The present invention is explained in particular with reference to vertically and horizontally displaceable track guidance units, wherein a displacement of the individual track guidance units at least in the vertical direction is described here in detail (track change by changing at least the height position of the track guidance units); in many applications, the displacement in the vertical direction is particularly expedient for uncoupling/coupling both mechanically and magnetically; in certain applications, however, the course of the tracks or rails and/or a longitudinal distance between the desired relative positions of the contact/coupling points between the rail and the respective track guidance unit can also be designed in such a way that the vehicle can be moved even with (additional) transverse displacement of the track guidance units. However, in certain applications, the course of the tracks or rails and/or a longitudinal distance between the desired relative positions of the contact/coupling points between the rail and the respective track guidance unit can also be designed in such a way that the vehicle can also be moved with (additional) transverse displacement of individual track guidance units. For many applications, however, the merely/exclusively vertical positioning of the individual track guidance units will already be a sufficient measure; the ability to activate an (electric) magnet can facilitate vertical positioning in the case of magnetic coupling. In this respect, a transverse offset is not always necessarily required as a process step to realise the transfer/track change described here, although it may be desirable or necessary for certain applications that the vehicle is set up for this type of movement in the transverse direction of the track guidance units, i.e. that the vehicle can realise not only a vertical displacement of the track guidance units, but optionally also a horizontal displacement of the track guidance units (in particular in the range of a few centimetres of transverse offset), for example if the longitudinal distance between the areas of the track in which repositioning/displacement is to take place requires this. The optional lane change kinematics described here therefore also includes optional lateral offset kinematics in some cases. Ultimately, it may also depend on the selected type and geometric design of the track guidance units (in particular on the size of a magnet/contact surface to the rail or on the width of a magnet/support and the geometric position of the coupling point, in particular on top or laterally) whether a transverse offset is dispensable or desired or even necessary. It is also possible that all track guide units are arranged at a fixed distance from the rail and (additionally) have electromagnets and/or permanent magnets connected to an actuator, so that the magnetic coupling can be strengthened or weakened as required, and that control on the rails can be achieved from the fixed arrangement and targeted activation of the electromagnets. It is also possible for the track guide units to be passively displaceable in the horizontal direction, for example if they have a left and a right magnet, so that in the area of a switch, where a left and a right rail/track can be selected, the right rail/track can be followed particularly easily by activating the right magnets or coupling the right magnets with the track/rail/track guide. In this case, however, an active cross offset and/or a roller connected to the track guide unit can prevent the distance between the magnet and rail/track from becoming too small.

The concept according to the invention described here with respect to one side (starboard, port, or right, left) of the vehicle or an axle can also be realised in mirror image on one/the other side of the axle, in particular also at an intermediate position, depending on the number of tracks/rails/guides provided. Usually, a track guidance system comprising two parallel tracks/rails is to be expected, so that the concept according to the invention is realised mirror-symmetrically on the right and left side of the vehicle at the corresponding sections, at least as far as the device-related aspects are concerned (however, the displacement and control method may vary in individual cases depending on the side or may be offset in time).

According to an embodiment example, the rail vehicle has a sensor system, in particular on the underside of the rail vehicle, for detecting the track or rail, in particular the current position and/or alignment of the switch. This favours a high degree of self-sufficiency of the rail vehicle, in particular the road-rail vehicle, in selecting the desired direction of travel, in particular independently of any measurement or communication technology equipment of the rail system or of a company operating the rail system. In this respect, the invention can also provide a vehicle that has only minimal system compatibility requirements, for example only with regard to the track gauge. Furthermore, this enables validation of the specified position and an additional assessment option for the magnetic coupling strength. The sensor system can comprise a position sensor and/or measuring unit for measuring the distance to the rail, in particular the switch, and/or speed of the rail vehicle and/or detection of the switch. The measuring unit can use electromagnetic waves of different wavelengths for this purpose. For example, the measuring unit can comprise a camera for visible and/or infrared light and/or a LiDAR sensor and/or a radar sensor. Corresponding technologies for other wavelength ranges can also be used. Alternatively or additionally, the measuring unit can include magnetic field sensors. In particular, the switch can be detected with high precision in the area of the switch.

According to an embodiment example, the rail vehicle is set up to receive instantaneous geoposition data of the rail vehicle in order to detect the track or rail, in particular the switch, in particular the instantaneous position and/or orientation of the switch, by means of or based on the instantaneous geoposition data of the rail vehicle. This further supports a lane change in accordance with the desired direction of travel against the switch position and ensures reliable detection of the lane or rail, for example in the event of a partial failure of the sensor system. Advantageously, the vehicle can travel on sections of track where there is no turnout based solely on geoposition data until it reaches the area of a turnout and a more precise detection of the turnout is required. This increases the computational and energy efficiency of the vehicle's evaluation unit, as the time-consuming evaluation of the measured values from the sensors can be dispensed with, at least on such sections of track.

According to an embodiment example, the rail vehicle has a detection device, a receiver unit, a memory unit and an evaluation unit. The detection device is set up so that it can detect a relative position between the rail vehicle and the switch based on measurement data from the sensor system and/or geoposition data and/or in conjunction with/by means of at least one marking or detection transmitter of a switch or control unit and/or using time and speed data of the rail vehicle. The receiver unit receives and the memory unit stores information about a desired direction of travel. The evaluation unit compares a direction of travel specified by the switch position with the desired direction of travel, whereby the control/regulation unit carries out a lane change in the area of the switch in accordance with the desired direction of travel and against the switch position in the event of a deviation between the desired direction of travel and the direction of travel specified by the switch position, in particular during travel.

According to an embodiment example, individual track guidance units, in particular the track guidance units for controlling the rail vehicle on the rails, can be individually displaced horizontally with a transverse offset that can be predefined by the rail vehicle and can be positioned in at least one corresponding intended transverse position corresponding to a transverse distance specified by the track/rail/track guidance. This simplifies cornering and can be utilised in particular when passing over a turnout in order to follow the desired direction, regardless of the current alignment of the turnout. Alternatively or additionally, it is advantageous if the track guidance units can be moved vertically between a lowered coupled position and a raised road position via a drive. This allows the rail vehicle to be uncoupled from the rails in designated areas and then continue on the road, in particular without the track guidance units colliding with the standardised distances in road traffic, such as kerb heights. Preferably, the respective lane guidance unit is height-adjustable both in the zero position and in the transverse position. This also makes it possible to adjust the relative position of guides that are predefined in a lateral direction by a rim or edge or similar. This provides the desired high variability not only with regard to lane changes independent of the switch position, but also independent of the direction of travel, i.e. bidirectional functionality. Last but not least, this also favours at least partially automated/automatable lane changing, in particular based on a movement path along the lane or along the rail system predefined by the control/regulation unit.

According to an embodiment example, at least two different track guidance units are assigned to each axle, namely at least one first track guidance unit at the front of the corresponding axle and at least one second track guidance unit at the rear of the corresponding axle.

According to an embodiment example, the rail vehicle has a control/regulation unit coupled to the at least one drive and/or actuator, which is set up to preset the height and/or lateral displacement or position of the track guidance units and/or to deactivate and/or activate an electromagnet, in particular also as a function of current position or image data. This further increases the accuracy of the coupling and simplifies the use of the rail vehicle for a user.

According to an embodiment example, the respective track guide unit has a support roller, in particular with a guide flange/track flange, which is set up to support the rail vehicle, in particular road-rail vehicle, on the correspondingly selected rail/track guide. This also enables the transfer of comparatively high loads, e.g. on rails; in this respect, support on wheels (or the like) can also be dispensed with while travelling on the rail(s). Since the vehicle can also be supported on at least one track guidance unit per axle when changing lanes, the structure or chassis is not overloaded when changing lanes.

According to an embodiment example, the respective track guide unit is set up to ensure guidance on the correspondingly selected rail/track guide by means of internal contact or external contact, in particular by means of a correspondingly arranged guide ring. This enables the respective track guide unit to be brought into the desired relative position either from the inside or from the outside or at least to be supported in the corresponding direction against the reaction forces acting. The person skilled in the art can select the most favourable configuration for the respective application, particularly depending on the design of the rail. Although contacting can also be realised both internally and externally, this can have disadvantages in terms of rail compatibility and low-friction and tilt-free guidance.

According to an embodiment example, the track guide units are set up to be transversely displaced outwards and/or inwards as desired. Not least, this also facilitates fine adjustment with regard to a relative transverse position of the track guide units relative to each other, in particular in the case of different track widths depending on the rail system (or in the area of switches). Alternatively or additionally, the respective track guide units are arranged on the inside or outside relative to the respective track and/or can be displaced in a lateral direction. Last but not least, this also enables a particularly advantageous method of support and (de)coupling between the vehicle and rail/track for the respective application.

According to one design example, the track guide units are each freely rotatable about a vertical axis. This also favours an advantageous alignment of the track guide units, in particular according to the current track/rail alignment.

According to an embodiment example, the track guide units that are to be mechanically coupled can be designed for this purpose, for example, as a roller with an at least approximately vertical axis (in particular if the vehicle is not to be/is not required to be supported on the track via the track guide units), or as a type of miniaturised rail/railway wheel (which is particularly advantageous in terms of supporting large weight forces), or for example also designed as a roller with an axis that is slightly inclined in relation to the horizontal plane for engaging on an underside of the rail profile. It is also possible to combine the above-mentioned features, both by using different designs for several track guide units and by combining a vertical axle and/or a miniaturised rail wheel and/or a roller for engaging the underside of the rail system in a single track guide unit. Track guide units that are to be magnetically coupled have, for example, a permanent magnet and/or an electromagnet connected to an actuator. The track guide units can be moved as required until the distance between the magnet and the rail is sufficiently small and the force effect sufficiently large. The permanent magnets can also be switchable and connected to an/the actuator. It is also possible to combine mechanical and magnetic coupling. For this purpose, both magnets (permanent magnets and/or electromagnets) can be integrated into the track guide units and rollers can be connected to the track guide unit as a kind of miniaturised rail/railway wheel, optionally with a wheel rim, for resting on the track/rail/track guide, whereby the rollers can both act as spacers and support the hold on the track/rail/track guide.

According to an embodiment example, the road-rail vehicle is designed as a road-rail vehicle with wheels intended for roads and optionally also for rails and with a chassis intended for roads and rails. Regardless of the ability to change lanes, this also enables the vehicle to be moved on conventional roads or similar surfaces without lane-bound movement paths. Alternatively or additionally, the rail vehicle, in particular the road-rail vehicle, has two axles with two wheels each and track guidance units arranged in front of and behind the wheels, i.e. four wheels and a large number of track guidance units. This provides good stability, whether on the wheels, on the track guidance units or by means of the track guidance units.

According to an embodiment example, at least one of the track guide units can be magnetically coupled to the track/rail/track guide. At least one track guide unit, preferably a plurality of the track guide units, has a permanent magnet or an electromagnet or a combination of permanent magnet and electromagnet and is coupled to the track/rail/track guide via the actuator and/or the drive. The use of a permanent magnet enables a secure coupling with the track/rail/track guide, in particular without having to add additional energy to the system. However, releasing the coupling can be a challenge, especially with strong permanent magnets. The design with only an electromagnet, on the other hand, offers great flexibility and enables a control system, for example by means of signalling devices and sensors and a control loop, to adjust the strength of the magnetic field as required and can make the need for a drive and vertical displaceability obsolete. A combination of electromagnet and permanent magnet may be preferred, whereby the electromagnet is set up to strengthen or weaken the magnetic field of the permanent magnet. This configuration is advantageous in terms of the energy required. In the magnetically coupled state, the electromagnet can be used to create a superimposed field that finely adjusts the force input via a control loop and keeps it constant, for example. In addition, the electromagnet can weaken the field emitted by the permanent magnet during a decoupling process so that the distance between the track guide unit and the track/rail/track guide can be increased more easily by means of a drive. All purely magnetic designs favour a long service life of the track guide units, as they do not have to be in physical contact with the track/rail/track guide and are therefore only subject to minimal wear.

According to an embodiment example, the magnetically couplable track guide units each have at least one permanent magnet and one electromagnet connected to the actuator, whereby the electromagnet is set up to strengthen, weaken or fine-tune the magnetic coupling with the track/rail/track guide. Alternatively or additionally, the track guide units have a switchable permanent magnet connected to the actuator. This has particularly favourable effects on the magnetic (decoupling)/coupling.

According to an embodiment example, track guide units show the bow side of at least one axle with a first pole of the electro/magnet facing the rail and the rear side of the at least one axle with a second pole of the electro/magnet, preferably different from the first, facing the rail. This configuration results in a particularly favourable force effect and safe magnetic coupling due to the high permeability differences between air and track/rail/track.

According to an embodiment example, the rail vehicle has both track guide units for fixing on the rail and track guide units for controlling on the rail, in particular in the area of a switch. The track guide units for fixing on the rail are, for example, positioned at a fixed distance from the track/rail/track guide or engaged with the track/rail/track guide and prevent the rail vehicle from slipping or unwanted decoupling. The track guide units for control on the rail, in particular in the area of a switch, are connected to the (front) wheels of the rail vehicle, for example, and ensure that the wheels follow the track/rail/track guide. In addition, they are designed to guide the wheels in the area of a switch along a selected/desired track regardless of the current alignment of the switch. For example, the track guidance units can have (electric) magnets to control this and can be moved horizontally. However, there can also be several track guidance units per front wheel, which are arranged at a horizontal distance from each other in front of the front wheel. In this case, the track guidance units for control are individually vertically displaceable, so that a vertical displacement of a “left” track guidance unit for control downwards causes the left track/rail/track guidance of a turnout to be followed due to the mechanical coupling and/or the stronger magnetic coupling of this track guidance unit. This allows a turnout to be “crossed” in the desired direction without stopping in front of the turnout. The separation of track guidance units into track guidance units for fixing and for control reduces the complexity of the vehicle's control unit.

According to one embodiment, the track guidance units for control are arranged on the rail on the bow side of the front axle of the rail vehicle and have at least two permanent magnets and/or electromagnets, whereby the permanent magnets and/or electromagnets are arranged in a V-shape and can be individually displaced and/or activated independently of one another. With this arrangement, the magnetic coupling with the desired track/rail/track guidance can be reinforced particularly easily so that the vehicle can follow the track/rail/track course selected by the driver/control unit at a switch. Away from points, the permanent magnets and/or electromagnets are arranged equidistant to the rail and exert a balanced force in the direction of the rail.

The aforementioned task is also solved by a method for operating a rail vehicle, in particular a two-way vehicle on rail/track guides, in particular a rail vehicle described above, in particular a two-way vehicle, wherein a relative position between the rail vehicle and the switch can be detected based on measurement data from a sensor system and/or from speed sensors and/or geoposition data and/or in conjunction with/by means of at least one marking or detection transmitter of a switch or control unit, wherein a control/regulation unit carries out a track change in the area of the switch in accordance with the desired direction of travel and against the switch position in the event of a deviation between the desired direction of travel and the direction of travel specified by the switch position during a journey, wherein the vehicle does not travel slower than 10 km/h in particular during the track change and wherein the rail vehicle is decoupled from a first track/rail/track guide and coupled to a second track/rail/track guide. This allows the vehicle to follow the rail system in the area of the switch (against the switch position) as if the switch were aligned in the specified direction of travel.

According to an embodiment example, the relative position between the rail vehicle and the switch is detected by a detection device of the rail vehicle, whereby information about a desired direction of travel is received by a receiver unit of the rail vehicle and stored by a memory unit of the rail vehicle, whereby an evaluation unit carries out a comparison between the direction of travel specified by the switch position and the desired direction of travel. This further supports the rail vehicle during an autonomous lane change in accordance with the desired direction of travel against the switch position.

The detection device can receive information in various ways, for example directly from a driver of the vehicle, from a navigation system or from a central control component, for example a control component of a logistics system.

According to an embodiment example, the decoupling from the first track/rail/track guide and the coupling to the second track/rail/track guide is carried out in such a way that at least two track guide units are each individually vertically and optionally also individually horizontally on one side of the rail vehicle, in particular road-rail vehicle, in a lateral direction transverse to the rail vehicle, in particular the road-rail vehicle, from a zero position to a transversely offset transverse position for coupling (either inwards or outwards, whereby a transverse displacement can also be optional depending on the design of the coupling partners track guidance unit and rail). Alternatively or additionally, decoupling from the first track/rail/track guide and coupling to the second track/rail/track guide is carried out in such a way that a magnetic coupling is generated/amplified by activating (electric) magnets, whereby the respective track guide units are/are arranged in different transverse and/or height positions and/or an (electric) magnet of a track guide unit located at a predefined distance from the track/rail/track guide is activated. The height position of either a/the currently uncoupled track guidance unit is shifted downwards until this track guidance unit ensures the coupling and guidance of the rail vehicle, in particular the road-rail vehicle, on the desired new track/rail/track section (in particular also on a transversely offset or curved (curved) track section). track section), so that the rail vehicle, in particular the road-rail vehicle, is mechanically and/or magnetically coupled to it, whereupon the other mechanically coupled track guidance units are lifted, so that the rail vehicle, in particular the road-rail vehicle, is moved away from the previous (or first) rail/track section. The rail vehicle, in particular two-way vehicle, is mechanically decoupled from the previous (or from a first) rail/track guide, in particular in the area of a switch or the height position is shifted downwards, until the magnetic field lines of a magnet arranged in the track guide unit propagate preferentially in the track/rail/track guide and the magnetic coupling is strong enough and/or until the track guide units are mechanically coupled to the new track/rail/track guide. In the event that all track guide units are coupled exclusively magnetically to the tracks/rails/tracks, the track guide units can easily remain in their vertical position at a switch and only be coupled to the desired track/rail/track guide via a transverse offset. In the case of a track guide unit that is coupled both magnetically and mechanically to the track/rail/track guides, the track guide unit can remain in its vertical position, provided that the mechanical coupling takes place via a wheel resting on top, so that this wheel can roll over the switch. This results in the aforementioned advantages.

In other words, the lane change can be realised either based on timed vertical position changes of the lane guidance units and/or based on a timed activation of an electromagnet, and (optionally) depending on the desired lane change situation, the respective lane guidance unit can also be displaced transversely/horizontally. The respective right and left track guidance units can optionally be displaced in pairs synchronised with each other, or the displacement can optionally be performed unilaterally individually, i.e. on the right side of the vehicle independently of the left side of the vehicle (the preferred procedure in each case also depends on the type of switch and rail guide and on the type of coupling of the track guidance units with the track/rail/track guide as well as on a possible connection of the right and left track guidance units to each other).

In the following, an exemplary procedure for moving or adjusting the track guidance units when travelling over a switch, in particular at a minimum speed of 10 km/h, is explained in the event that there is a deviation between the desired direction of travel and the direction of travel specified by the switch position, whereby this deviation results in particular from a comparison carried out by an evaluation unit of the vehicle.
a) The vehicle is initially located on a straight-ahead rail section in a section of a first track/rail/track guide in front of a switch that is set to straight-ahead travel, for example with all track guide units in the lowered position or in a state coupled to the track.
b) When driving onto the turnout or travelling over the turnout (in particular after the turnout position has either been detected by sensors/measurement technology or specified via a position specification), the track guidance units of the front axle are raised if they are mechanically connected to the turnout, and the other rear track guidance units are/remain down.
c) The track guide units are then transferred to the second track/rail/track guide at the turn-off point of the switch along the desired direction of travel, i.e. for coupling the front track guide units, these are first lowered if they were raised for decoupling, and coupled with the second track/rail/track guide. The rear track guide units are then raised if the rear track guide units are mechanically coupled to the track/rail/track guide; the rear track guide units can otherwise “run along” via the switch if they are magnetically coupled to the track/rail/track guide (in particular by displacement) without being raised.
d) Now the corresponding front wheels are coupled to the new/desired direction of travel, and the track guidance units of the rear axle can be moved at the turn-off point of the switch, so that in this example all track guidance units are now coupled to the desired track/rail/track guidance again.

It can be seen from this that when a turnout set to “straight ahead” is turned, it can be moved both with a vertical movement of the track guide units and, if necessary, also by a transverse offset of individual track guide units. According to the present disclosure, the track guide units can or must therefore also be offset in the transverse direction, in particular individually and independently of each other; depending on the course of the rails, this can be advantageous or necessary, and this is also advantageous with regard to track width adjustment, but a transverse offset of the track guide units does not necessarily always have to be carried out for the repositioning according to the invention. In the case of track guide units that have two or more (electro) magnets arranged in a V-shape, which can be individually displaced or activated, the transverse offset is not necessary, for example. In this case, a track can be selected, for example, by bringing one of the V-shaped magnets closer or by activating only one of the V-shaped magnets.

According to an embodiment example, at least two track guidance units are assigned to each axle of the vehicle, namely at least one first track guidance unit at the front of the corresponding axle and at least one second track guidance unit at the rear of the corresponding axle of the vehicle. In this case, in an exemplary procedure when driving onto the switch or travelling over the switch, the front track guide units (on the front axle's bow side) are raised if they are mechanically coupled to the first track/rail/track guide or, in the case of a purely magnetic coupling, are magnetically decoupled from the first track/rail/track guide and the other rear track guide units are/remain down/coupled. The track guide units are then moved accordingly at the turnout's turning point. For the mechanical coupling of the front track guide units (bow side of the front axle) with the second track/rail/track guide, which leads in the desired direction of travel against the switch position, these are first lowered or, in the case of a purely magnetic coupling, magnetically coupled with the second track/rail/track guide and then the rear track guide units (rear side of the front axle) are raised, if these are mechanically coupled to the first track/rail/track guide, which leads in the direction of travel specified by the switch position, or magnetically decoupled from the first track/rail/track guide in the case of a purely magnetic coupling. The corresponding front wheels are now coupled to the second track/rail/track guide, and at least one of the rear track guide units (at the rear of the front axle) can be moved at the turning point of the points, so that in this example all track guide units of the front axle are now coupled to the second track/rail/track guide again. This can then be carried out accordingly for the rear wheels.

The sequence of the displacement of the individual track guidance units described here is only an example of the procedural embodiment of the invention; optionally, a variation can be made, for example, such that first the front axle track guidance units on the front side, then the rear axle track guidance units on the front side, then the rear axle track guidance units on the front side and then the rear axle track guidance units on the rear side are raised and lowered as soon as the respective wheels or track guidance units approach the switch or are in the corresponding relative position to the turning point (which point in time or which relative position can, for example, be detected by sensors/measurement technology and transmitted to a control component). The front axle track guidance units are raised and lowered as soon as the respective wheels or track guidance units approach the switch or are in the corresponding relative position to the turning point (which time or relative position can, for example, be detected by sensors/measurement technology and transmitted to a control component of the vehicle).

The person skilled in the art will recognise from the present description of the arrangement and control of the track guidance units that the track guidance units described here can optionally be mounted and controlled with independent suspension/independent wheel suspension (irrespective of their absolute number).

Changing lanes at a turnout can also be described with reference to different longitudinal sections of the track/rail, here using the example of a rail system with two tracks and a vehicle with at least two axles (i.e. at least four wheels and at least four track guidance units):

The vehicle approaches a track/rail switch with initially all track guidance units at the bottom or coupled to the track/rail. When a first longitudinal section is reached, for example, a transverse position of the front track guidance units is adjusted so that they are aligned with the track/rail desired by the driver/vehicle/board computer. If the front track guidance units are in mechanical contact with the track/rail/track guide, it may be necessary to first raise the track guidance units, i.e. to change their height position by means of a drive, before the transverse position is adjusted and the front track guidance unit is then coupled with the desired track/rail. It is also possible to use the actuator to deactivate/activate a switchable permanent magnet and/or an electromagnet as described above in order to decouple a magnetically coupled track guidance unit from the “undesired” track/rail and to switch/deactivate it again for the purpose of magnetic (assisted) coupling. The coupling can take place at a given point in time (which can also be predetermined by a position detection control system), for example as soon as the front/front axle of the vehicle reaches a subsequent second longitudinal section of the track/rail (in particular an area in which a turning point or the adjustable rail section of the switch is already overlapped and a corresponding transverse distance between the overlapping rail sections is still present). The corresponding rear track guide units are then decoupled from the “unwanted” track/rail. The front track guidance units are connected to the front tyres in such a way that the vehicle is forced onto the desired track. If the rear track guidance units are only magnetically coupled or mechanically coupled only by rollers resting on the track/rail from above, the vehicle can simply follow the front track guidance units (track guidance units for steering) and pull the rear track guidance units (for fixing) over the switch until the rear track guidance units are coupled/couplable with the desired track/rail/track guidance. Other forms of mechanical coupling may require the rear track guidance units to be moved vertically. In these cases, the rear track guidance units, if they are also magnetically coupled to the track/rail, can first be magnetically decoupled using the actuator and mechanically decoupled using the drive until the vehicle has rolled so far over the switch to a longitudinal position (detected using a sensor, for example) that the rear track guidance units would be coupled exclusively to the desired track/rail when vertically displaced downwards. From this longitudinal position, the track guidance units are lowered and coupled to the desired track/rail, and the vehicle can continue travelling as before. The vehicle is therefore able to drive over a turnout regardless of its current alignment. In particular, the alignment of the turnout itself can change during the crossing process without causing the vehicle to jam with the track guidance units. An advantage of a vehicle whose track guidance units are exclusively magnetically coupled or mechanically coupled only by rollers resting on the track/rail from above also becomes apparent in this context, as this vehicle is able to drive over the turnout without lifting the track guidance units, which considerably speeds up and/or simplifies the process.

The following describes an exemplary lane change in a track guidance system with two tracks and a vehicle with at least two axles, whereby at least two different track guidance units are assigned to each axle, namely at least one first track guidance unit at the front of the corresponding axle and at least one second track guidance unit at the rear of the corresponding axle (i.e. at least four wheels and at least eight track guidance units).

The vehicle approaches a track/rail switch with initially all track guidance units at the bottom or coupled. Initially, only the rear track guidance units (in particular of the first axle or optionally all axles) are engaged with the track/rail (if necessary, decouple the bow-side track guidance units as a preparatory measure). The track guidance units on the bow side are therefore in a raised position or are moved there at a given point in time (which can also be predetermined by a position detection control system); as soon as the front/leading axle of the vehicle passes over the switch (in particular reaches an area in which a turning point or the adjustable rail section of the switch is reached), the track guidance units on the bow side are in a raised position. the adjustable rail section of the turnout is already overlapped and there is still a corresponding transverse distance between the overlapping rail sections), the right and/or left bow-side track guidance units are lowered (i.e. coupled to the track/rail), and the corresponding rear-side track guidance units are then raised (decoupled); the vehicle can therefore now follow the desired track path; thanks to the different longitudinal positions of the front and rear track guidance units, the point at which the actual position of the switch would have caused the vehicle to be guided differently has been skipped or bridged, so to speak; optionally, depending on the design of the rail/switch, this bridging manoeuvre can also be achieved with the described adjustment of the track guidance units on only one side of the vehicle (right or left); in particular, this also depends on which switch position is present; the vehicle can be guided by means of the track guidance units on only one side of the vehicle (right or left). The vehicle can use the visually/optically detected switch position, for example, to determine whether the respective track guidance unit is moved to the right or left side of the vehicle, or whether/how the track guidance units are moved to both sides of the vehicle. As soon as the front/leading axle reaches a further subsequent longitudinal section of the track/rail (in particular an area in which the adjustable rail section of the turnout is already overlapped and a corresponding transverse distance between the overlapping rail sections is already present), the track guidance units on the other side (starboard or port) can optionally be relocated accordingly. This additional longitudinal section-related measure (or its timing) This additional longitudinal section-related measure (or its timing) can also depend in particular on the radius of curvature of the switch; This is because the turning point is clearly defined on one rail (contact area of two rail sections), whereas on the other opposite parallel rail the turning point is not a point-shaped area in the geometric sense, but a comparatively long section depending on the radius of curvature of the turnout, which, depending on the design of the track guidance units, can only be used again after a certain longitudinal distance (longitudinal displacement)—only at/after this point does it make sense to displace the corresponding track guidance units (in this respect, the corresponding bridging manoeuvre of the track guidance kinematics may differ individually for each vehicle side on the right and left).

When coupling the respective track guidance unit on the bow side with the new desired track, a transverse offset can also be optionally carried out, depending on the longitudinal distance and the width of the rail or the track guidance unit; the additional transverse offset may be desired or preferred depending on the application; preferably, the chassis or the mounting of the track guidance units is basically set up to carry out such a transverse offset either per axle or individually for all individual track guidance units (in particular optionally inwards or outwards). The chassis or the mounting of the track guidance units is generally set up to realise such a transverse offset either per axle or individually for all individual track guidance units (in particular optionally inwards or outwards), so that a vehicle can be provided with a very high degree of independence or self-sufficiency.

Alternatively, the lane change can also be carried out as follows, depending on the design of the rail system or the switch:

The vehicle approaches a track/rail switch with only the rear track guide units (in particular of all axles) in engagement with the track/rail; the front track guide units are in a raised position; as soon as the front/front-most axle of the vehicle reaches the corresponding longitudinal section of the track/rail (in particular an area in which the adjustable rail section of the turnout is already overlapped and a corresponding transverse distance between the overlapping rail sections is still present), at least one of the right or left bow-side track guidance units is lowered (i.e. coupled to the track/rail), depending on the desired direction of the vehicle, and the corresponding rear-side track guidance unit is raised (decoupled); as soon as the front/foremost axle reaches a corresponding subsequent longitudinal section of the track/rail (in particular an area in which the adjustable rail section of the turnout is already overlapped and a corresponding transverse distance between the overlapping rail sections is already present), the track guidance units on the other side (starboard or port) are displaced accordingly; when coupling the respective bow-side track guidance unit to the new desired track, a transverse offset can also be carried out as an option.

Instead of purely mechanically coupled track guidance units, mechanically and/or magnetically coupled track guidance units can also be used.

According to an embodiment example, a time of activation of an electromagnet(s) and/or the height displacement and optionally also a lateral displacement of the track guidance units is defined as a function of an instantaneous position of the rail vehicle, in particular road-rail vehicle, on the track/rail/track guidance, in particular in that the time is specified by means of a control/regulation unit to at least one drive and/or actuator of the rail vehicle, in particular road-rail vehicle, in particular in the area of a switch. Last but not least, this also favours autonomous or at least partially autonomous actuation of the lane change kinematics as a function of an instantaneous relative position of the rail vehicle, in particular a road-rail vehicle, and/or as a function of an instantaneous switch position. The track change kinematics is characterised, for example, by analogous displacement of paired track guidance units (respective bow-side or rear-side track guidance units), or by a specific time sequence of the displacement of bow-side and rear-side track guidance units, and/or by a lifting/swivelling mechanism or exclusively by a lifting/lowering movement. In the event that all track guidance units are magnetically coupled, there is no need to change the vertical position at all when travelling over the turnout, provided that the front track guidance units are already oriented along the desired direction.

The aforementioned task is also solved by using at least two track guidance units on an axle of a rail vehicle, in particular a road-rail vehicle, namely at least one first track guidance unit at the front of the corresponding axle and at least one second track guidance unit at the rear of the corresponding axle, in particular in a rail vehicle described further above, wherein the individual track guidance units can be displaced independently of one another individually vertically and optionally also individually horizontally in a lateral direction transverse to the rail vehicle (or transverse to the intended direction of travel) from a zero position into a displaced position, in particular also into a transversely displaced transverse position, such that the rail vehicle can be decoupled from a first rail/track guide. direction) from a zero position into an offset position, in particular also into a transversely offset transverse position, in such a way that the rail vehicle can be decoupled from a first rail/track guide and coupled to a second rail/track guide, in particular in the region of a switch. This results in the aforementioned advantages.

The above-mentioned object is also achieved by using at least two track guidance units in a rail vehicle, in particular a two-way vehicle, in particular in a rail vehicle described above, wherein the individual track guidance units can be activated independently of one another and/or individually vertically and optionally also individually horizontally in a lateral direction transverse to the rail vehicle (or direction) from a zero position into an offset position, in particular also into a transversely offset transverse position, such that the rail vehicle can be decoupled from a first track/rail/track guide and can be coupled to a second rail/track guide, in particular in the region of a switch. This results in the aforementioned advantages.

The aforementioned problem is also solved by a system comprising at least one rail vehicle, in particular a road-rail vehicle, in particular a rail vehicle described above, and at least one first and second rail/track guide, wherein the rail vehicle can be decoupled from the first rail/track guide by a method of the type described above and can be coupled to the second rail/track guide, in particular in the region of a switch. This results in the aforementioned advantages.

According to an embodiment example, the system is set up to predetermine transport routes of the rail vehicle, in particular two-way vehicle, against a switch position or independently of a current switch position along at least a first and second rail/track guide. This also provides flexibility/variability independent of the current status and/or the current utilisation/traffic of the track/rail system.

According to an embodiment example, the system has a plurality of at least partially autonomously travelling rail vehicles, in particular road-rail vehicles, which are transported (can be transported) along a plurality of transport paths, wherein the system defines transfer points from rail to road or vice versa, wherein a control component (control/regulation unit) of the system controls/regulates the transport paths between first and second transfer points (or transfer points), wherein at least a subset of the rail vehicles, in particular road-rail vehicles, are rail-coupled at least in sections. This also favours an advantageous scalability/application of the invention in systems with numerous movement paths.

A particularly preferred embodiment of the traffic system is characterised by the fact that it contains two control components. One of the control components directly controls the vehicles that can be decoupled from a first track/rail/track guide, while the other control component controls switch settings of the rail system. At least some of the vehicles can travel independently of the first track/rail/track guide and another part of the vehicles is linked to the track/rail/track guide, in particular including the positions of the rails/switches etc.

Such a system has the particular advantage that both vehicles that can be decoupled from the track/rail/track guide and vehicles that cannot be decoupled from the track/rail/track guide can be used in a shared rail system.

Such an embodiment of the traffic system is also particularly advantageous because vehicles that can be decoupled from the respective lane/rail/track guides can be integrated into the system, allowing free capacities to be utilised. For example, it is possible for lane-independent vehicles to overtake other vehicles and/or avoid other vehicles.

The invention also relates to a road-rail vehicle comprising a rigid hard wheel and at least one rubber-tyred road wheel arranged coaxially with the hard wheel, a road-rail vehicle with a chassis set up for track/rail/track guidance, on which at least two axles are each mounted with wheels, and with a plurality of track guidance units which are individually vertically movable independently of one another between a lowered guide position and a raised road position via at least one drive of the road-rail vehicle, a use of a road-rail wheel as a wheel of a road-rail vehicle and a method for operating a road-rail vehicle with a road-rail wheel using a radius change of the hard wheel.

For travelling on roads and rails, wheels are generally known in the state of the art that have both a rail wheel and a road wheel on one axle. For example, U.S. Pat. No. 1,853,572 shows a triple wheel consisting of two road wheels with rubber tyres and a rigid rail wheel with a wheel rim. The radius of the rubber-tyred wheels is larger than the radius of the rail wheel when the tyres are inflated. To travel on the rail, air is released from the respective air tube of the rubber-tyred road wheels so that the rail wheel is used to travel on the rail.

In the state of the art, rail wheels of two-way bicycles with at least one road wheel are usually conical or have a wheel rim to guide the wheel along rails.

Therefore, it is further a task of embodiments of the invention to provide a corresponding two-way wheel which overcomes the disadvantages of previously established technologies and increases flexibility, a two-way vehicle which can travel both on the road and on rails or other hard smooth surfaces, a use of a two-way wheel as a wheel of a two-way vehicle and a method for operating a two-way vehicle with a two-way wheel. This task is solved by the following two-way wheel, whereby the features of the embodiments described below can be combined with one another, unless this is explicitly negated.

The proposed two-way wheel has a rigid hard wheel with a wheel surface made of a first material and at least one rubber-tyred road wheel arranged coaxially to the hard wheel with a wheel surface made of a second material, the second material being softer than the first material. It is characterised by the fact that the hard wheel is convex or flat. This means that the radius of the hard wheel in the centre of a contact surface or its running surface is at least as large as in the edge areas of the contact surface. For the purposes of this application, a hard wheel is a rigid wheel whose running surface is made of an inelastic or at least only slightly elastic material and which is suitable for travelling on smooth, rigid surfaces such as rails. The convex or flat design of the present hard wheel has the advantage over conically designed rail wheels that the hard wheel is suitable for travelling on a large number of flat surfaces and is only in contact with a rail from above, without its own guidance from the side. This makes it possible, for example, to drive over points or tracks against their position, thereby increasing the flexibility of the two-way wheel. However, a hard wheel as described here has the special feature compared to a conical rail wheel that it does not have to be held on the rail by a wheel rim, but that track guide units can be used for a road-rail vehicle with a hard wheel when travelling on the rail in order to keep the vehicle on the rail.

With a flat design, the hard wheel has a constant radius when viewed over its cross-section. In the case of a convex design, the hard wheel has a maximum radius at at least one point between the edge regions when viewed over the cross-section. The constant or maximum radius of the hard wheel is to be understood as the first radius in the context of this application. Road wheels with rubber tyres are generally also convex. The maximum radius of the road wheel is to be understood as the second radius. Rubber-tyred road wheels can be any form of conventional road wheel, for example air-filled road wheels or those that do without air, such as the Uptis model from Michelin.

According to an advantageous embodiment of the invention, the ratio of the first radius to the second radius can be reversibly changed. This further increases the flexibility of the two-way wheel. By varying the ratio of the radius of the hard wheel and the rubber-tyred road wheel or the rubber-tyred road wheels, it is possible to optionally set that all wheels of the two-way wheel are in contact with the ground or that only the hard wheel or only the road wheel or the road wheels are in contact. Due to the reversible changeability, any change to the ratio can be cancelled again.

A preferred embodiment of the invention is characterised in that the hard wheel has a radius-changing mechanism which can change the radius of the hard wheel and/or the road wheel has a radius-changing mechanism which can change the radius of the road wheel. The inclusion of a radius-changing mechanism in the hard wheel and/or the road wheel offers the advantage that the radius is changed, in particular changed automatically, when the mechanism is activated. Radius-changing mechanisms are generally included in the prior art. Thus, a large number of known radius-changing mechanisms are suitable for changing the radius of the hard wheel and/or the radius of the road wheel.

A particularly preferred embodiment of the invention is characterised in that the hard wheel has spokes, whereby the spokes are formed by pneumatic or hydraulic working cylinders and the radius-changing mechanism of the hard wheel can change the length of the spokes by means of the working cylinders. Actuating the mechanism causes the working cylinders to stretch or lengthen. The circumference or tread is divided into even segments for this purpose. In the initial state with a smaller radius, the segments can overlap each other proportionally, for example, so that when the mechanism is actuated, the hard wheel still has a continuous running surface and locking of the wheel is prevented.

A further embodiment of the invention is characterised by the fact that the two-way wheel has exactly one rubber-tyred road wheel, with the hard wheel preferably being arranged on the side of the two-way wheel facing the axle. A twin wheel is thus provided. The arrangement of the hard wheel on the side facing the axle makes it possible, particularly in the case of vehicles with a larger track width, to place the hard wheels at a distance from each other that corresponds to the width of rail tracks.

According to a further advantageous embodiment of the invention, the two-way wheel has exactly two rubber-tyred road wheels, with the hard wheel preferably being arranged between the two rubber-tyred road wheels. This design provides a triple wheel. This results in the advantage of increased weight absorption. This design can offer advantages in terms of stability, particularly with narrow road wheels with rubber tyres.

A further preferred embodiment of the invention is characterised by the fact that the hard wheel and the rubber wheel are combined in a common rim, and the different wheel surfaces made of the first material and the second material are integrated in the tyre. This can be done, for example, via a ring made of the first material that is embedded in the second material. The first material can be steel, metal or another material that has a particularly low elasticity.

With a further embodiment of the invention, a road-rail vehicle is provided, in particular according to one of the embodiments described herein, wherein a plurality of the wheels of the road-rail vehicle, preferably all wheels of the road-rail vehicle, are formed by road-rail wheels. The road-rail vehicle thus provided is suitable both for travelling on the road and for travelling with track/rail/track guidance due to its two-way wheel. The track guidance units are used to ensure guidance on the tracks, while the hard wheel itself preferably rests on top of the rails.

According to a further embodiment of the invention, a road-rail wheel is used as a wheel of a road-rail vehicle, wherein the road-rail vehicle uses at least one rubber-tyred road wheel for travelling on the road, wherein the hard wheel of the road-rail wheel hangs or runs on the axle at a distance from the road, and the road-rail vehicle uses the hard wheel for travelling on the rail, wherein the road wheel or the road wheels of the road-rail wheel hang or hang on the axle at a distance, in particular at a horizontal distance, from the rail. This offers the advantage that a hard wheel is protected when travelling on the road and that the rubber-tyred road wheel or the rubber-tyred road wheels are not stressed when travelling on the rail or a similar smooth surface and therefore have an increased service life.

Advantageously, the two-way wheel is used in such a way that when changing between travelling on the road and travelling on the rail, the ratio of the radii of the hard wheel and the rubber-tyred road wheel or the rubber-tyred road wheels is changed, whereby in particular only one of the radii, preferably only the radius of the hard wheel, is changed during the change. This further increases the service life of the hard wheel and the road wheels with rubber tyres, as contact with the respective unsuitable surface is prevented. In this way, the flexibility of the two-way wheel is also utilised and a particularly simple change between road and rail is made possible.

A further embodiment of the invention provides a method for operating a two-way vehicle with a two-way wheel using a change in radius of the hard wheel. It is characterised in that, in one step of the method in a road operation, the radius of the hard wheel is selected to be so small that the hard wheel has no connection to the road, so that the road wheel or the road wheels are responsible for the locomotion of the road-rail vehicle during travel on the road, and in a further step in a rail operation, the radius of the hard wheel is selected to be so large that the rubber-tyred road wheel has no connection to the rails, so that the hard wheel is responsible for the locomotion of the road-rail vehicle during travel on the rail. The method thus provided offers the advantage that the road-rail vehicle has an increased service life and the road-rail vehicle uses the appropriate running gear for every surface.

Advantageously, in a further step of the method, a change is made from the road to the rail or from the rail to the road and the radius of the hard wheel is increased or reduced during the change, wherein, in a step in road operation, the road-rail vehicle is aligned along the rails at an intersection between the road network and the rail network and remains stationary above the rails and the radius of the hard wheel is increased until the hard wheel carries the road-rail vehicle and, in a further step in rail operation, the radius of the hard wheel is reduced at a suitable point until the road wheel carries the road-rail vehicle. This makes it possible to switch advantageously between two different transport networks. It is preferable for this change to take place quickly, for example due to a particularly fast-acting radius-changing mechanism. For example, traffic jams can be easily avoided with suitable route planning. Advantageously, the change takes place in areas where the rails and the road are at the same height, as is the case with railway crossings, for example. The change can also be made using lifts, cranes or similar aids. The advantage of using areas where the rails and the road are at the same level is that they are generally abundant and/or can be built quickly, so there is no need for costly retrofitting or preparation of the transport networks to use the method. No ramp or the like is required either. The process provided is therefore characterised by a particularly high degree of flexibility and rapid deployment with many possible applications.

The invention can also be described by the features shown below. The features shown below can be combined both with each other and with the following illustrations of preferred embodiments using the figures, with particularly preferred combinations of features being emphasised by reference to previously illustrated combinations of features.
AA) Rail vehicle, in particular a road-rail vehicle with a chassis equipped for track/rail/track guidance, on which at least two axles are each mounted with wheels, and with a plurality of track guidance units which can be individually moved vertically between a lowered guidance position and a raised road position independently of one another via at least one drive of the rail vehicle, in which at least two different track guidance units are assigned to each axle, namely at least one first track guide unit at the front of the corresponding axle and at least one second track guide unit at the rear of the corresponding axle, the individual track guide units being individually displaceable independently of one another in such a way that the rail vehicle can be decoupled from a first track/rail/track guide for a track change and can be coupled to a second track/rail/track guide, in particular in the region of a switch along the track/rail/track guide.
AB) Rail vehicle, preferably corresponding to AA, whereby the individual track guide units can be individually displaced horizontally with a transverse offset that can be predefined by the rail vehicle and can be positioned in at least one corresponding intended transverse position corresponding to a transverse distance specified by the track/rail/track guide.
AC) rail vehicle, preferably corresponding to AB, whereby the respective track guidance unit is height-adjustable both in the zero position and in the transverse position.
AD) Rail vehicle, preferably corresponding to AA, wherein the rail vehicle is set up to overcome a track/rail switch independently of a/the current switch position, in particular by exclusively vertical displacement of the individual track guide units; and/or wherein the rail vehicle is set up to position each track guide unit individually in the vertical and horizontal direction both with respect to a/the zero position and with respect to a/the transverse position, in particular by means of the at least one drive.
AE) Rail vehicle, preferably corresponding to AA, wherein the rail vehicle has a control/regulation unit coupled to the at least one drive, which is set up to predetermine the vertical and/or transverse displacement or position of the respective front and rear track guidance units.
AF) Rail vehicle, preferably corresponding to AA, wherein the respective track guide unit has a support roller, in particular with a guide ring, which is set up to support the rail vehicle on the correspondingly selected track/rail/track guide; and/or wherein the respective track guide unit is set up to ensure guidance on the correspondingly selected track/rail/track guide by internal contacting or by external contacting, in particular in each case by means of a correspondingly arranged guide ring.
AG) Rail vehicle, preferably corresponding to AA, wherein the track guide units are arranged to be optionally displaced laterally outwards and/or inwards; and/or wherein at least some of the track guide units are arranged inwards or outwards relative to the respective track and/or can be displaced in a lateral direction.
AH) Rail vehicle, preferably corresponding to AA, whereby the track guidance units are each freely rotatable about a vertical axis.
AI) Rail vehicle, preferably corresponding to AA, wherein the track guide units are designed as rollers with an axis slightly inclined relative to the horizontal plane for engaging an underside of the rail profile.
AJ) Rail vehicle, preferably corresponding to AG, wherein the track guide units are arranged to be optionally displaced laterally outwards and/or inwards; and/or wherein at least some of the track guide units are arranged inwards or outwards relative to the respective track and/or are displaceable in a lateral direction, wherein the track guide units are each mounted so as to be freely rotatable about a vertical axis and wherein the track guide units are arranged as a roller with an axis slightly inclined relative to the horizontal plane for engagement on an underside of the rail profile.
AK) Rail vehicle, preferably corresponding to AA, wherein the rail vehicle is designed as a road-rail vehicle with wheels intended for roads and optionally also for rails and with a chassis intended for roads and rails; and/or wherein the road-rail vehicle has two axles each with two wheels and front and rear track guidance units arranged on both sides of the wheels, i.e. four wheels and eight track guidance units.
AL) Rail vehicle, preferably corresponding to AA, wherein the rail vehicle is designed as a road-rail vehicle with wheels intended for roads and optionally also for rails and with a chassis intended for roads and rails; and/or wherein the road-rail vehicle has two axles, each with two wheels, and an arbitrarily high number of front and rear track guidance units arranged on both sides of the wheels, i.e. four wheels and an arbitrarily high number of track guidance units.
AM) Rail vehicle, in particular a road-rail vehicle with a chassis equipped for track/rail/track guidance, on which at least two axles are each mounted with wheels, and with a plurality of track guidance units which can be individually coupled to the track/rail/track guidance independently of one another via at least one drive and/or actuator of the rail vehicle, wherein the individual track guide units can be individually displaced and/or activated independently of one another in such a way that the rail vehicle can be decoupled from a first track/rail/track guide for a track change and can be coupled to a second track/rail/track guide, in particular in the region of a switch along the track/rail/track guide, wherein at least one of the track guide units can be magnetically coupled to the track/rail/track guide.
AN) Rail vehicle, preferably corresponding to AM, wherein at least one track guide unit, preferably a plurality of the track guide units, has a permanent magnet or an electromagnet or a combination of permanent magnet and electromagnet and is coupled to the track/rail/track guide via the actuator and/or the drive.
AO) rail vehicle, preferably corresponding to AM, wherein the track guide units each have at least one permanent magnet and at least one electromagnet connected to the actuator, wherein the electromagnet is set up to strengthen, weaken or fine-tune the magnetic coupling with the track/rail/track guide or wherein the track guide units have a switchable permanent magnet connected to the actuator.
AP) Rail vehicle, preferably corresponding to AM, wherein the rail vehicle, in particular on at least one track guidance unit, has a sensor for measuring a distance from the rails in order to detect a rail and/or to measure a distance from a rail.
AQ) Rail vehicle, preferably corresponding to AM, wherein the rail vehicle has a control/regulation unit coupled to the at least one drive and/or actuator, which is set up to predetermine the vertical and/or transverse displacement or position of the track guidance units and/or to activate the magnet.
AR) Rail vehicle, preferably corresponding to AM, wherein the rail vehicle has both track guidance units for fixing on the rail and track guidance units for controlling on the rail, in particular in the area of a switch.
AS) Rail vehicle, preferably corresponding to AR, wherein the track guidance units are arranged for control on the rail on the bow side of the front axle of the rail vehicle and have at least two permanent magnets and/or electromagnets, wherein the magnets and/or electromagnets are arranged in a V-shape and can be individually displaced and/or activated independently of one another.
AT) Rail vehicle, preferably corresponding to AM, wherein individual track guidance units, in particular the track guidance units for controlling the rail vehicle on the rails, can be individually displaced horizontally with a transverse offset that can be predefined by the rail vehicle and can be positioned in at least one corresponding intended transverse position corresponding to a transverse distance specified by the track/rail/track guidance and/or the track guidance units can be moved vertically between a lowered coupled position and a raised road position via a drive.
AU) Rail vehicle, preferably corresponding to AM, wherein the rail vehicle is set up to overcome a track/rail switch independently of a/the current switch position, in particular by exclusively vertically displacing individual track guide units; and/or wherein the rail vehicle is set up to position each track guide unit individually in the vertical and horizontal direction both with respect to a/the zero position and with respect to a/the transverse position, in particular by means of the at least one drive; and/or wherein the rail vehicle is set up to deactivate/activate an/the electromagnet.
AV) rail vehicle, preferably corresponding to AM, wherein the track guide units are arranged to be optionally displaced laterally outwards and/or inwards; and/or wherein at least some of the track guide units are arranged inwards or outwards relative to the respective track and/or are displaceable in the lateral direction.
AW) Rail vehicle, preferably corresponding to AM, wherein the rail vehicle is designed as a road-rail vehicle with wheels intended for roads and optionally also for rails and with a chassis intended for roads and rails; and/or wherein the road-rail vehicle has two axles with two wheels each and track guidance units arranged in front of and behind the wheels, i.e. four wheels and a plurality of track guidance units.
AX) Rail vehicle, preferably corresponding to AM, wherein track guide units on the bow side of at least one axle point towards the rail with a first pole of the permanent magnet or electromagnet and track guide units on the rear side of the at least one axle point towards the track/rail with a second pole, preferably different from the first, of the permanent magnet or electromagnet.
CA) Method for coupling a rail vehicle to track/rail/track guides, in particular a rail vehicle according to AA, wherein at least two track guide units are each individually vertically and optionally also individually horizontally displaceable on an axle of the rail vehicle in a lateral direction transversely to the rail vehicle for the coupling, namely at least one first track guide unit on the bow side of the corresponding axle and at least one second track guide unit on the rear side of the corresponding axle, wherein the respective bow-side and rear-side track guidance unit are/are arranged in different transverse and/or height positions, and wherein the height position of either one or the currently unloaded track guidance unit is shifted downwards, until this track guidance unit ensures the support and guidance of the rail vehicle on the desired track/rail/track section, so that the rail vehicle is coupled thereto, whereupon the height position of the other track guidance unit is raised, so that the rail vehicle is decoupled from the previous track/rail/track guidance, in particular in the region of a switch.
CB) Method, preferably in accordance with CA, wherein a point in time of at least the height displacement and optionally also a transverse displacement of the front and rear track guidance units is defined as a function of an instantaneous longitudinal position of the rail vehicle on the track/rail/track guidance, in particular in that the point in time is specified by means of a control/regulation unit to at least one drive of the rail vehicle, in particular in the region of a switch.
CC) Method, preferably according to CA, wherein the method is carried out based on measurement data from sensors of the rail vehicle which detect the track or rail, in particular by means of or based on instantaneous geoposition data of the rail vehicle and/or by detecting an instantaneous position/alignment of a switch and/or in conjunction with/by means of at least one marker or detection transmitter of a switch or control unit.
CD) Method for coupling a rail vehicle to track/rail/track guides, in particular a rail vehicle according to AM, wherein at least two track guide units are each individually vertically displaceable on one side of the rail vehicle, optionally also individually horizontally displaceable in a lateral direction transverse to the rail vehicle for the coupling and/or wherein a magnetic coupling is generated/amplified via an activation of magnets, wherein the respective track guide unit is/are arranged in different transverse and/or vertical positions and/or a magnet of a track guide unit located at a predefined distance from the track/rail/track guide is deactivated/activated.
CE) method, preferably according to CD, wherein a time of activation of an electromagnet/magnet and/or the height displacement and optionally also a transverse displacement of the track guidance units is defined as a function of an instantaneous position of the rail vehicle on the track/rail/track guidance, in particular in that the time is specified by means of a control/regulation unit to at least one drive and/or actuator of the rail vehicle, in particular in the region of a switch.
CF) Method, preferably according to CD, wherein the method is carried out based on measurement data from sensors of the rail vehicle which detect the track or rail, in particular by means of or based on instantaneous geoposition data of the rail vehicle and/or by detecting an instantaneous position/alignment of a switch and/or in conjunction with/by means of at least one marking or detection transmitter of a switch or control unit and/or by calculating an instantaneous position of the rail vehicle on the basis of time and speed data.
EA) Use of at least two track guidance units on an axle of a rail vehicle, preferably corresponding to AA, namely at least one first track guidance unit at the front of the corresponding axle and at least one second track guidance unit at the rear of the corresponding axle, in particular in a rail vehicle accordingly, wherein the individual track guide units can be displaced independently of one another individually vertically and optionally also individually horizontally in a lateral direction transverse to the rail vehicle from a zero position into a transversely displaced transverse position in such a way that the rail vehicle can be decoupled from a first track/rail/track guide and can be coupled to a second track/rail/track guide, in particular in the region of a switch.
EB) Use of at least two track guide units, in particular in a rail vehicle, preferably corresponding to AM, wherein the individual track guide units can be activated independently of one another and/or can be displaced individually vertically and optionally also individually horizontally in a lateral direction transverse to the rail vehicle from a zero position into a transversely offset transverse position in such a way that the rail vehicle can be decoupled from a first track/rail/track guide and can be coupled to a second track/rail/track guide, in particular in the region of a switch.
FA) System comprising at least one rail vehicle, in particular a rail vehicle, preferably corresponding to AA, and at least one first and second track/rail/track guide, wherein the rail vehicle can be decoupled from the first rail/track guide by a method corresponding to AM and can be coupled to the second track/rail/track guide, in particular in the region of a switch.
FB) system, preferably corresponding to FA, wherein the system is set up to predetermine transport paths of the rail vehicle independently of an instantaneous switch position along at least a first and second track/rail/track guide.
FC) system, preferably corresponding to FA, wherein the system comprises a plurality of at least partially autonomously travelling rail vehicles, in particular two-way vehicles, which are transported along a plurality of transport paths, wherein the system defines transfer points from rail to road or vice versa, wherein a control component of the system controls/regulates the transport paths between first and second transfer points, wherein at least a subset of the two-way vehicles are rail-coupled at least in sections.
FD) system, preferably corresponding to FA, wherein the system has a control component for track guidance units of vehicles and wherein the control component is set up such that the control component can control the track guidance units of at least some of the vehicles such that the track guidance units can be individually displaced independently of one another such that the vehicle can be uncoupled from a first track/rail/track guide for a track change and can be coupled to a second track/rail/track guide, in particular in the region of a switch along the track/rail/track guide.
FE) system, preferably corresponding to FD, wherein the system contains at least two control components, wherein one of the control components can directly control the vehicles which can be decoupled from a first track/rail/track guide, and wherein the other control component can control switch positions of the rail system, so that at least some of the vehicles can travel independently of the first track/rail/track guide and another part of the vehicles is bound to the track/rail/track guide, in particular including positions of the rails/switches, etc.
FF) system, preferably corresponding to FE, whereby both vehicles that can be decoupled from the track/rail/track guide and vehicles that cannot be decoupled from the track/rail/track guide can be used in a jointly usable rail system.
FG) system, preferably corresponding to FF, whereby vehicles that can be decoupled from the respective track/rail/track guides are integrated into the system, by means of which free capacities can be utilised.
FH) system, preferably corresponding to FG, whereby lane-independent vehicles can perform overtaking manoeuvres during a stop of non-lane-independent vehicles at stops.
FI) System comprising at least one rail vehicle, in particular a rail vehicle, preferably corresponding to AM, and at least one first and second track/rail/track guide, wherein the rail vehicle can be decoupled from the first rail/track guide by a method corresponding to CD and can be coupled to the second track/rail/track guide, in particular in the region of a switch.
FJ) system, preferably corresponding to FI, wherein the system is set up to predetermine transport paths of the rail vehicle independently of an instantaneous switch position along at least one first and second track/rail/track guide.
FK) system, preferably corresponding to FI, wherein the system comprises a plurality of at least partially autonomously travelling rail vehicles, in particular two-way vehicles, which are transported along a plurality of transport paths, wherein the system defines transfer points from rails to road or vice versa, wherein a control component of the system controls/regulates the transport paths between first and second transfer points, wherein at least a subset of the two-way vehicles are rail-coupled at least in sections.
FL) system, preferably corresponding to FI, wherein the system has a control component for track guidance units of vehicles and wherein the control component is set up in such a way that the control component can control the track guidance units of at least some of the vehicles in such a way that the track guidance units can be activated independently and/or displaced individually from one another in such a way that the vehicle can be decoupled from a first track/rail/track guide for a track change and can be coupled to a second track/rail/track guide, in particular in the region of a switch along the track/rail/track guide.
FM) system, preferably according to FL, wherein the system contains at least two control components, wherein one of the control components can directly control the vehicles which can be decoupled from a first track/rail/track guide, and wherein the other control component can control switch positions of the rail system, so that at least some of the vehicles can travel independently of the first track/rail/track guide and another part of the vehicles is bound to the track/rail/track guide, in particular including positions of the rails/switches etc.
FN) system, preferably corresponding to FM, whereby both vehicles that can be decoupled from the track/rail/track guide and vehicles that cannot be decoupled from the track/rail/track guide can be used in a jointly usable rail system.
FO) system, preferably corresponding to FN, whereby vehicles that can be decoupled from the respective track/rail/track guides are integrated into the system, by means of which free capacities can be utilised.
FP) system, preferably according to FO, whereby lane-independent vehicles can perform overtaking manoeuvres during a stop of non-lane-independent vehicles at stops.
HA) A two-way wheel comprising a rigid hard wheel having a wheel surface of a first material and at least one rubber-tyred road wheel arranged coaxially with the hard wheel and having a wheel surface of a second material, the second material being softer than the first material, wherein the hard wheel is convex or flat.
HB) Two-way wheel, preferably corresponding to HA, the hard wheel having a first radius and the rubber-tyred road wheel having a second radius, the ratio of the first radius to the second radius being reversibly variable.
HC) Two-way wheel, preferably corresponding to HB, wherein the hard wheel has a radius-changing mechanism which can change the radius of the hard wheel and/or the road wheel has a radius-changing mechanism which can change the radius of the road wheel.
HD) Two-way wheel, preferably corresponding to HC, wherein the hard wheel has spokes, wherein the spokes are formed by pneumatic or hydraulic working cylinders and the radius-changing mechanism of the hard wheel can change the length of the spokes by means of the working cylinders.
HE) Two-way wheel, preferably corresponding to HA, wherein the two-way wheel has exactly one rubber-tyred road wheel, wherein the hard wheel is preferably arranged on the side of the two-way wheel facing the axle.
HF) Two-way wheel, preferably corresponding to HB, the two-way wheel having exactly two rubber-tyred road wheels, the hard wheel preferably being arranged between the two rubber-tyred road wheels.
HG) Two-way wheel, preferably corresponding to HA, whereby the hard wheel and the rubber wheel are combined in a common rim, and the different wheel surfaces of the first material and the second material are integrated in the tyre.
HH) Two-way vehicle having a chassis which is set up for track/rail/track guidance and on which at least two axles are each mounted with wheels, and having a plurality of track guidance units which can be moved individually and vertically between a lowered guidance position and a raised road position independently of one another via at least one drive of the two-way vehicle, wherein a plurality of the wheels of the two-way vehicle, preferably all the wheels of the two-way vehicle, are formed by two-way wheels, in particular by two-way wheels corresponding to HA.
HI) Two-way vehicle, preferably corresponding to HH, wherein at least two different track guidance units are associated with each axle, namely at least one first track guidance unit at the front of the corresponding axle and at least one second track guidance unit at the rear of the corresponding axle, wherein the individual track guidance units can be individually displaced independently of one another in such a way that the two-way vehicle can be decoupled from a first track/rail/track guide for a track change and can be coupled to a second track/rail/track guide, in particular in the region of a switch along the track/rail/track guide.
HJ) Two-way vehicle, preferably corresponding to HI, wherein the individual track guide units can be individually displaced horizontally with a transverse offset which can be predefined by the two-way vehicle and can be positioned in at least one corresponding intended transverse position corresponding to a transverse distance predetermined by the track/rail/track guide, wherein the respective track guide unit can be adjusted in height both in the zero position and in the transverse position, and in that the road-rail vehicle is set up to overcome a track/rail switch independently of a/the current switch position, in particular by exclusively vertical displacement of the individual track guidance units and/or in that the road-rail vehicle is set up to position each track guidance unit individually in the vertical and horizontal direction both with respect to a/the zero position and with respect to a/the transverse position, in particular by means of the at least one drive.
HK) Use of a road-rail wheel as a wheel of a road-rail vehicle, wherein the road-rail vehicle uses at least one rubber-tyred road wheel for travelling on the road, wherein the hard wheel of the road-rail wheel hangs or runs on the axle at a distance from the road, and the road-rail vehicle uses the hard wheel for travelling on the rail, wherein the road wheel or the road wheels of the road-rail wheel hang or hang on the axle at a distance, in particular at a horizontal distance, from the rail.
HL) Use of a two-way wheel, preferably according to HK, wherein the two-way vehicle changes the ratio of the radii of the hard wheel and the rubber-tyred wheel or the rubber-tyred wheels during a change between travelling on the road and travelling on the rail, wherein in particular only one of the radii, preferably only the radius of the hard wheel, is changed during the change.
HM) Method for operating a two-way vehicle, in particular a two-way vehicle, preferably corresponding to HH, with a two-way wheel using a change in radius of the hard wheel, wherein in one step in a road operation the radius of the hard wheel is selected to be so small that the hard wheel has no connection to the road, so that the road wheel or the road wheels are responsible for the locomotion of the road-rail vehicle during the journey on the road, and in a further step in a rail mode, the radius of the hard wheel is selected to be so large that the rubber-tyred road wheel has no connection to the rails, so that the hard wheel is responsible for the locomotion of the road-rail vehicle during the journey on the rail.
HN) method, preferably according to HM, wherein in one step the vehicle is changed from the road to the rail or from the rail to the road and the radius of the hard wheel is increased or reduced during the change, wherein the road-rail vehicle is aligned along the rails at an intersection between the road network and the rail network in a step in road operation and remains stationary above the rails and the radius of the hard wheel is increased until the hard wheel carries the road-rail vehicle and in a further step in rail operation the radius of the hard wheel is reduced at a suitable point until the road wheel carries the road-rail vehicle.
HO) method, preferably according to HN, whereby the change is carried out in areas where the rails and the road are at the same height, for example at level crossings.
HP) Method according to, preferably according to HN, wherein in a step for coupling the two-way vehicle to track/rail/track guides at least two track guide units are each individually vertically and optionally also individually horizontally displaceable on an axle of the rail vehicle in a lateral direction transversely to the rail vehicle for the coupling, wherein at least one first track guide unit is arranged on the bow side of the corresponding axle and at least one second track guide unit is arranged on the rear side of the corresponding axle, wherein the respective bow-side and rear-side track guidance unit are/are arranged in different transverse and/or height positions, and wherein the height position of either one or the currently unloaded track guidance unit is shifted downwards, until this track guidance unit ensures the support and guidance of the road-rail vehicle on the desired track/rail/track section, so that the road-rail vehicle is coupled thereto, whereupon the height position of the other track guidance unit is raised, so that the rail vehicle is decoupled from the previous track/rail/track guidance, in particular in the region of a switch.

### BRIEF DESCRIPTION OF THE DRAWINGS

The invention is described in more detail in the following drawing figures, whereby reference is made to the other drawing figures for reference signs that are not explicitly described in a respective drawing figure. It shows:

FIGS. 1 and 2 each show a perspective view of a vehicle on any flat or uneven surface (in particular on a road or on asphalt) on the one hand and a vehicle on a rail guide on the other hand, in each case according to an embodiment example, the vehicle having eight track guidance units, which are named individually here;

FIGS. 3 and 4 each show a perspective view of a vehicle according to an embodiment example on a rail guide, on the one hand in an arrangement in front of a switch of the rail system, which is set to straight-ahead travel, and on the other hand at the moment of passing over the switch when travelling straight-ahead, with the corresponding relative positions of the track guidance units;

FIGS. 5, 6, 7A, 7B, 8 each show a perspective view of a vehicle according to an embodiment example on a rail guide, initially in an arrangement in front of a switch of the rail system (section X3), which is set to straight-ahead travel, whereby different moments/times are shown when travelling over a switch of the rail system for the purpose of cornering/turning, i.e. against the switch set to straight-ahead travel, with the corresponding relative positions of the track guidance units;

FIGS. 9 and 10 each show a perspective view of a vehicle according to an embodiment example on a rail guide, on the one hand in an arrangement in front of a switch of the rail system, which is set for a turning manoeuvre, and on the other hand at the moment of passing over the switch when turning, with the corresponding relative positions of the track guidance units;

FIGS. 11, 12, 13A, 13B, 14 each show a perspective view of a vehicle according to an embodiment example on a rail guide, initially in an arrangement in front of a switch of the rail system, which is set for a turning process, whereby different moments/times are shown when driving over a/the switch of the rail system for the purpose of travelling straight ahead, i.e. against a switch set for turning, with the corresponding relative positions of the track guidance units;

FIGS. 15, 16, 17, 18A, 18B, 19 each show in perspective view of a vehicle according to a further embodiment example in situations in front of, above and behind a switch or a turning point of a switch, whereby the vehicle independently initiates a turning process, contrary to the current switch position (straight ahead);

FIGS. 20a and 20b show a first magnetically couplable track guidance unit of a rail vehicle according to one embodiment of the invention;

FIGS. 21a and 21b show a second magnetically couplable track guidance unit of a rail vehicle according to one embodiment of the invention;

FIGS. 22a and 22b show a third track guidance unit of a rail vehicle according to one embodiment of the invention;

FIGS. 23a to 23ca show magnetically and mechanically couplable track guidance unit of a rail vehicle according to one embodiment of the invention;

FIGS. 24a to 24ca show magnetically coupled track guidance unit for control on a rail of a rail vehicle according to one embodiment of the invention;

FIGS. 25a and 25b show two-way vehicle according to one embodiment of the invention on different surfaces;

FIG. 26 shows a detail of a track guide unit for fixing to the rail of a rail vehicle according to one embodiment of the invention;

FIGS. 27a to 27c show in each case a perspective view of a vehicle according to a further embodiment example in situations in front of, above and behind a switch or a turning point of a switch, wherein the vehicle, which according to one embodiment of the invention has track guidance units for fixing, in this case magnetic track guidance units, and track guidance units for controlling at a switch, independently initiates a turning process, contrary to the momentary switch position;

FIGS. 28a to 28c show in each case a perspective view of a vehicle according to a further embodiment example in situations in front of, above and behind a switch or a turning point of a switch, wherein the vehicle, which according to one embodiment of the invention has a plurality of track guidance units, independently initiates a turning process, counter to the momentary switch position;

FIG. 29a shows a side view of a two-way wheel as a twin wheel;

FIG. 29b shows a front view of the two-way wheel showing the running surface and the radius ratio;

FIG. 29c shows a side view of the two-way wheel with a second radius ratio;

FIG. 29d shows a front view of the two-way wheel showing the running surface with the second radius ratio;

FIG. 30a shows a side view of a two-way wheel as a triplet wheel;

FIG. 30b shows a front view of the two-way wheel showing the running surface and the radius ratio;

FIG. 30c shows a side view of the two-way wheel with a second radius ratio;

FIG. 30d shows a front view of the two-way radius with second radius ratio for viewing the running surfaces;

FIG. 31a shows a hard wheel of a two-way wheel with a radius-changing mechanism in a first state;

FIG. 31b shows the hard wheel in a second state with an enlarged radius;

FIG. 32a shows a foldable rubber wheel that can be divided into segments and has a radius-changing mechanism;

FIG. 32b shows the foldable rubber wheel in a partially folded state; and

FIG. 32c shows the folded rubber wheel.

### DETAILED DESCRIPTION

The invention is first described in general terms with reference to all reference signs. Details are explained in connection with the respective figure.

A track-bound/rail-couplable vehicle (100) is provided, in particular a two-way vehicle which, together with a rail guide, forms a vehicle/rail system (200). The vehicle (100) is set up for independent or autonomous or automated lane changing, namely from a first lane/rail/track guide (121) to a second lane/rail/track guide (122), in particular in the area of a switch (123), in particular during a journey, preferably at a minimum speed of 10 km/h, wherein the first track/rail/track guide (121) leads in a direction of travel predetermined by the switch position and the second track/rail/track guide (122) leads in a desired direction of travel against the switch position (123). Optionally, this lane change can be carried out in a controlled/regulated manner, in particular by means of a control/regulation unit (104) and based on measured values from sensors (103) communicating therewith (e.g. position sensors and/or measuring units) and/or geoposition data and/or in conjunction with/by means of at least one marking or detection transmitter of the points (123) or control unit and/or on the basis of time and speed data of the vehicle (100).

For example, the (two-way) vehicle is a vehicle with two axles and one right and one left wheel (110) per axle.

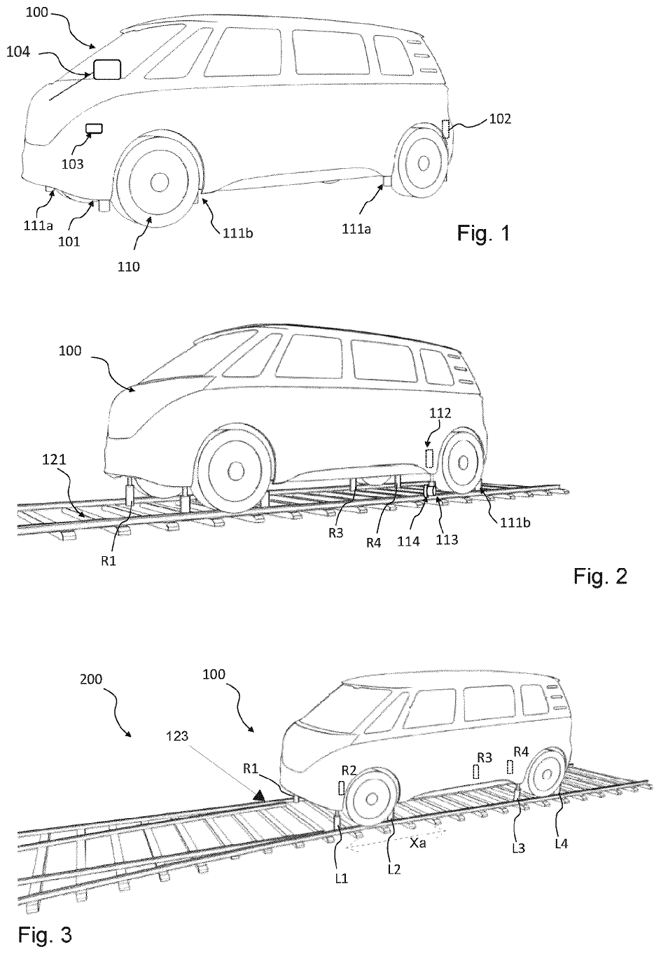

FIG. 1 shows a vehicle (100) with retracted or raised track guidance units (111). The vehicle (100) has two adjustable track guidance units (111) per wheel, namely a track guidance unit (111a) at the front and a track guidance unit (111b) at the rear. In other words, in front of and behind each ground contact point (wheel contact point), a track guidance unit (111) adjustable at least in its height position is provided. The vehicle rests on wheels (110) on the ground, e.g. on a road or a meadow or a gravel path. The control/regulation unit (104) is connected to the drives acting on the track guidance units, for example the drive (102) shown as an example, by a control/regulation connection. This control/regulation connection, which can optionally be implemented for an automatable transfer, is for example wireless or is realised by a wired connection line not shown for reasons of simplification.

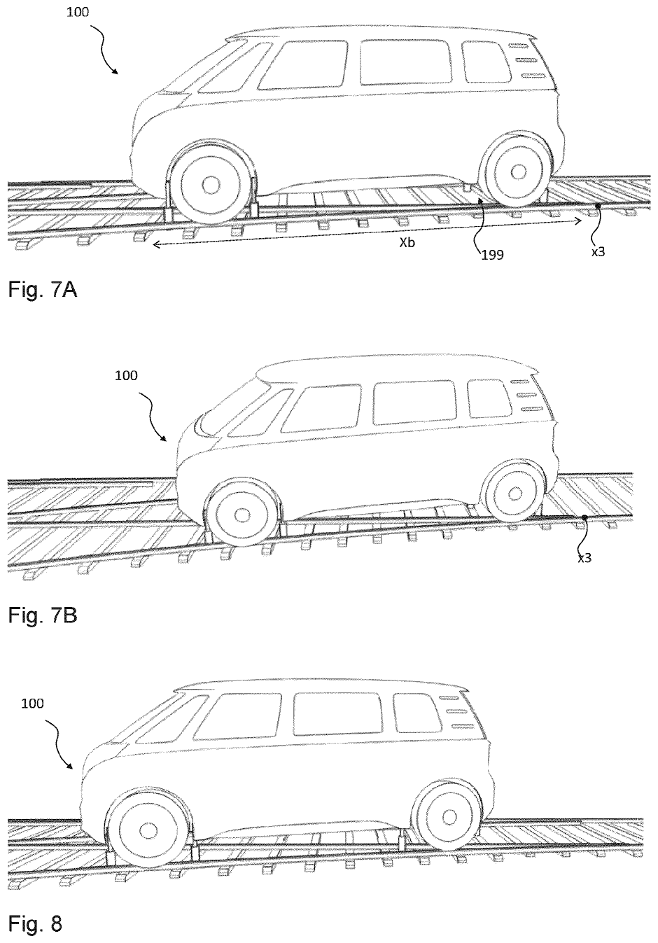

For ease of understanding, these track guidance units (111) can also be designated as follows: left-hand track guidance units L1, L2, L3, L4 and right-hand track guidance units R1, R2, R3, R4 (each numbered consecutively from front to rear). The lane guidance units (111) are preferably mounted on the chassis (101) and are adjustable via at least one drive (102). This arrangement forms a/the lane change kinematics (199) (in FIG. 7A), by means of which the vehicle can carry out the lane change in an autonomous manner, in particular against a switch position (123).

In FIG. 2, the vehicle (100) is shown in a tracked-in arrangement on two rails of a rail system, whereby all track guide units (111) are extended or are in a lower engagement position. Optionally, the track guide units can be aligned for loading and carrying the vehicle and adjusted in height (set height position) in such a way that both wheel axles are raised and the wheels do not contact the rails at all, or that only one wheel axle is raised and the other wheel axle (e.g. one/the one used to drive the wheels) is not in contact with the rails. axle responsible for driving the wheels) is still positioned in such a way that the corresponding wheels can contact the rails (see illustration in FIG. 2 with raised front axle), or that both wheel axles are barely or only partially relieved and all wheels continue to contact the rails. The configuration that makes sense in each case can also depend on the vehicle type and the type of use or the rails/track and can be set individually for each application.

The height position of each track guide unit can be set/preset, for example, by means of a hydraulic ram (112). It is advantageous, but not necessary, that the track guide units each have at least one running wheel (113) (or at least one support roller) for the purpose of guiding on the rails (and optionally also for supporting the vehicle in the sense of a support) and have a wheel flange or guide flange (114).

FIGS. 2 and 3 illustrate the selected nomenclature/designation of the individual track guidance units (111). The left-hand track guidance units of the two chassis axles are labelled L1, L2, L3, L4, and the corresponding right-hand track guidance units are labelled R1, R2, R3, R4, with the number increasing from the front to the rear of the vehicle (100) (L1 thus corresponds to the foremost left-hand track guidance unit, also generally labelled 111a in the other figures, and R4 thus corresponds to the rearmost right-hand track guidance unit, also generally labelled 111b in the other figures).

The individual track guide units (the reference sign 111 is generally used for this purpose) are shown here essentially abstracted as rectangles, in particular to illustrate that the present invention is not limited to a specific type of coupling between rail and corresponding track guide unit; in this respect, the support rollers described elsewhere here can also alternatively be provided by a different type of coupling/coupling both only on the rail sides and also below the rail (in particular also depending on the respective type of track/rail to be used of a particular track/rail system). In this respect, the rectangles selected here for the illustration can also include any other drive and bearing or support components of the respective track guidance unit.

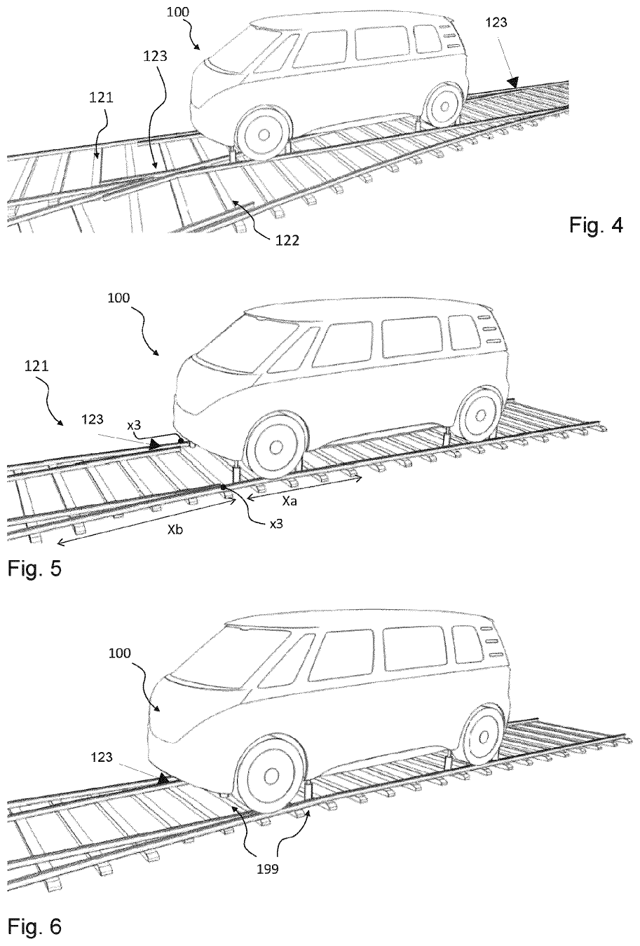

FIG. 3 shows a situation in which the vehicle (100) is located in a straight-ahead section (Xa) of the rail guide in front of a switch (123) set to straight-ahead, with all track guidance units (111) in engagement with the rails (lowered position). The wheels of the front axle can either run on the rails or drive the vehicle, or the corresponding track guidance units (111) are extended so far that the wheels are mounted freely in the air (without contact with the rails). FIG. 4 shows a situation in which the vehicle passes the points (123) in a straight line in accordance with the points position (no lane change against the points position desired).

FIGS. 5 and 6 show a situation in which the vehicle (100) is shortly before a turnout (123) which, contrary to the turnout position set to straight ahead, is not to be passed in a straight line, but the vehicle (100) is to make an independent lane change. In FIG. 5, the vehicle (100) initially approaches with all lane guidance units at the bottom or coupled. When reaching a first longitudinal section (Xa) in FIG. 6, the front axle track guidance units are not engaged with the track/rail. The vehicle adjusts the individual track guidance units (111) as follows:

In the situation shown in FIG. 6, the front bow-side track guidance unit LI is raised (this also applies to R1, but is not visible). In the situation according to FIG. 7A and FIG. 7B, in the area of the second longitudinal section (Xb), after passing the turning point (x3) of the switch (123), all track guidance units of the first axle (L1, R1, L2, R2) are coupled to the rail again and all bow-side track guidance units (L3, R3) on the rear axle are lifted or disengaged and all rear-side track guidance units 111b, L2, R2 are lifted or disengaged. out of engagement and all rear track guide units 111b, L2, R2, L4, R4 are in engagement with the rails (lowered position).

In FIGS. 6, 7A and 7B, a situation is shown in which the front axle of the vehicle (100) is only located above a/the turning point (x3) of the switch (123), whereby there (or the corresponding front-side track guidance units (111a) are moved downwards and the rear-side track guidance units (111b) are raised (thus the turning point (x3) has been bypassed thanks to the track guidance units arranged with different longitudinal positions in front of and behind the respective wheel); as soon as the rear axle of the vehicle (100) reaches the turning point (x3), the front-side and then the rear-side track guidance units are repositioned accordingly. After the entire vehicle has passed the turning point (FIG. 8), the rear track guidance units (111b) of the respective axle can optionally also be brought back into engagement with the rails.

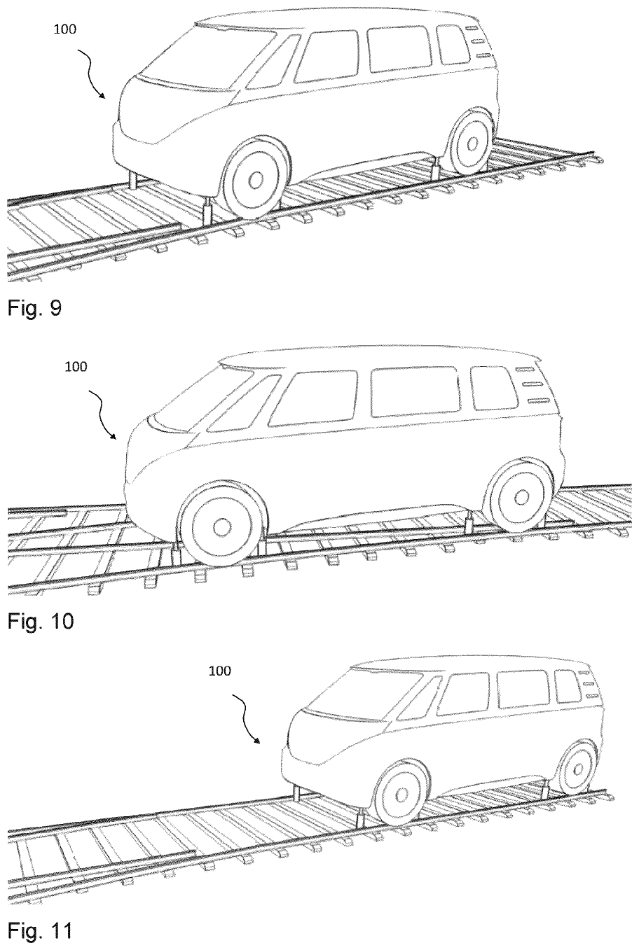

FIGS. 9 and 10 show a situation in which the vehicle follows the course of the track determined by a switch position, in this case to turn off.

FIGS. 11 to 14 show a process in which the vehicle bypasses the current switch position (123), which is orientated towards turning, in order to drive straight ahead.

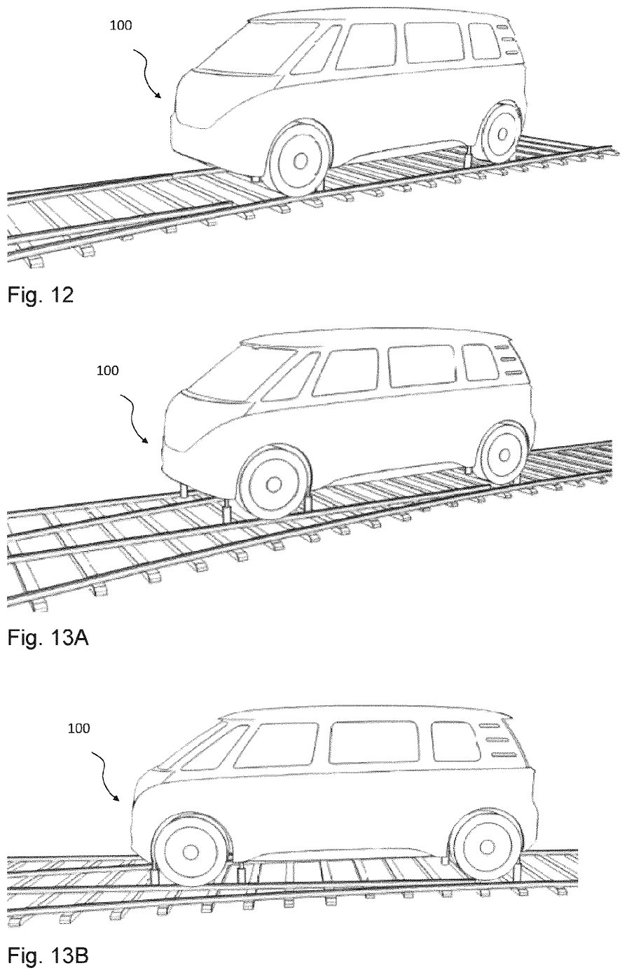

In FIG. 12, the front bow-side track guidance units are raised.

In FIG. 13A and 13B, the rear axle's bow-side track guidance units are raised.

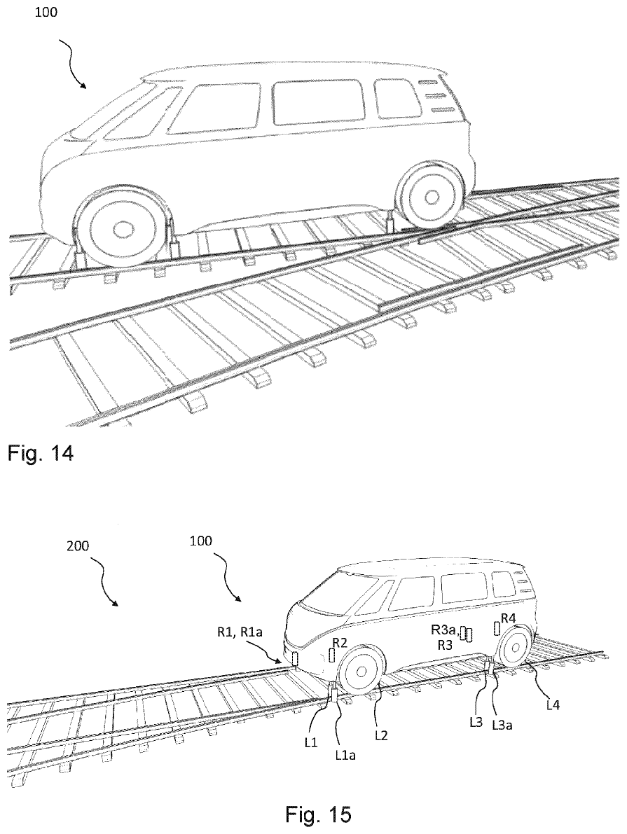

In FIG. 14, the rear track guidance units are still held in the raised position until the vehicle has left the turning area behind.

The following figures describe a further design example in which additional redundant track guidance units L1a, L3a, R1a, R3a are provided at the front or rear (here: only redundant track guidance units at the front) and the vehicle thus has track guidance units both inside and outside the track at the front and thus has six track guidance units per axle and twelve on the entire vehicle.

FIG. 15 shows a situation with all track guidance units moved downwards.

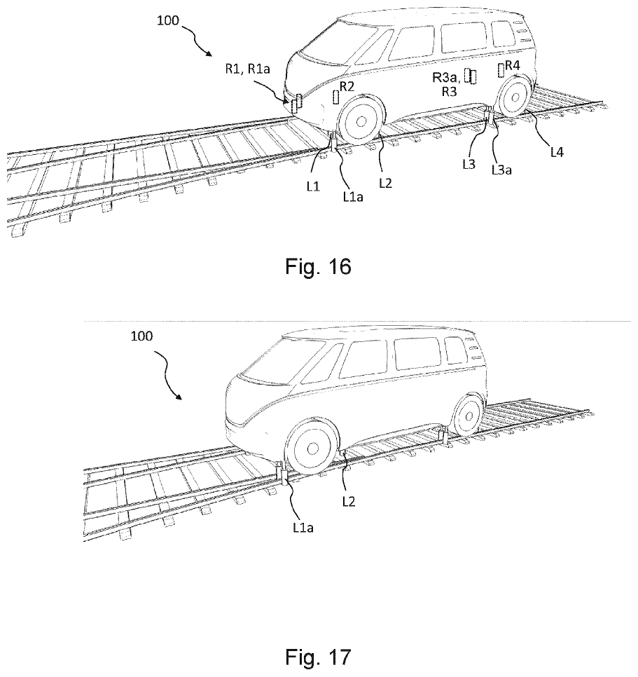

In the situation shown in FIG. 16, the right front bow-side track guidance units (L1, R1a) and the front rear-side track guidance units (L2, R2) are raised and the left front bow-side track guidance units (L1a, R1a) are displaced downwards.

In FIG. 17, the front track guide units (L1, L1a, R1, R1a) are moved downwards and the front rear track guide units (L2, R2) are raised.

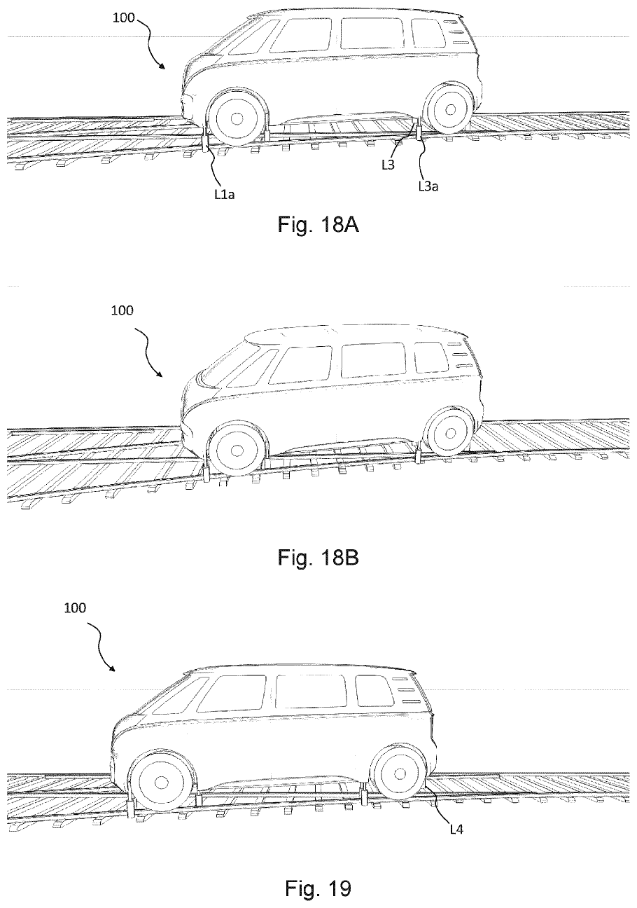

In FIG. 18A and 18B, the right rear bow-side track guide units (L3, R3a) are shifted upwards.

In FIG. 19, the rear track guidance units (L4 and R4) are moved upwards.

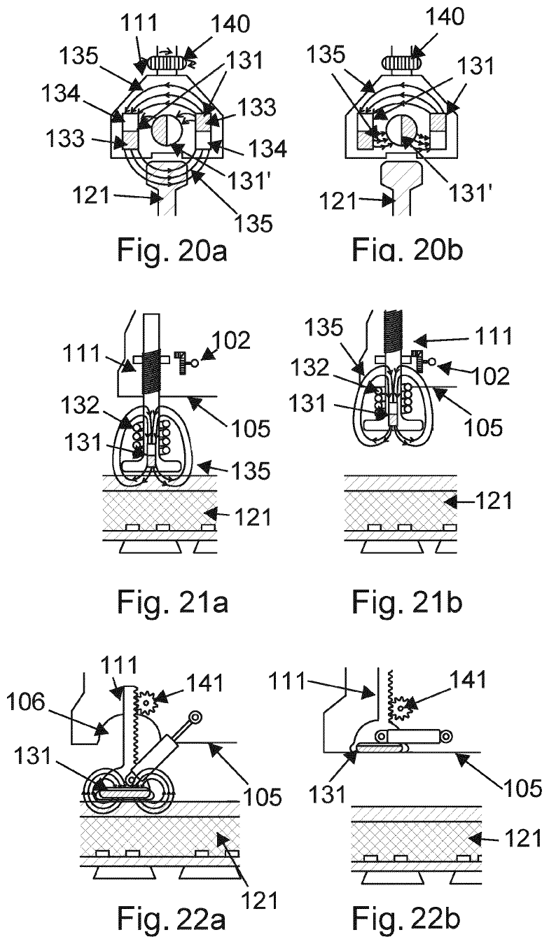

FIG. 20 shows a first magnetically couplable track guide unit (111) of a rail vehicle not shown here, in particular a road-rail vehicle, according to one embodiment of the invention. In FIG. 20a, the track guide unit is magnetically coupled to the track/rail/track guide (121). For this purpose, the track guide unit has two rigidly arranged bar magnets (131) and a rotatably mounted cylindrical magnet (131′) in its interior. One bar magnet (131) has its north pole (133) pointing upwards, while the other bar magnet (131) has its south pole (134) pointing upwards. The north and south poles of the cylindrical magnet (131′) each point towards the bar magnet (131) located to the left and right of the cylindrical magnet (131′). In this case, the cylindrical magnet (131′) is connected to an actuator (not shown) via a gear wheel (140) and rotates the cylindrical magnet (131′) by 180 degrees when activated. The characteristics of the magnetic field resulting from the respective orientation of the cylindrical magnet (131′) are approximately indicated by means of the field lines (135). The track guide unit (111) consists of a soft magnetic material in which the field lines (135) preferably spread out between the permanent magnets (131, 131′). In the state of the track guide unit (111) shown in FIG. 20a, the field lines (135) emanating from the north pole (133) of the first bar magnet (131) are forced to bridge the air gap between the track guide unit (111) and the track/rail (121) twice due to the orientation of the cylindrical magnet (131′) in the centre in order to be able to propagate in the likewise soft-magnetic rail material and reach the other bar magnet (131). FIG. 20b shows the state in which the cylindrical magnet (131′) inside is rotated by 180 degrees and serves as a source (or sink) for the field lines (135) propagating in the direction of the rail. In this case, the track guide unit (111) is field-free towards the outside and is not coupled to the track/rail/track guide (121).

FIG. 21 shows a second magnetically couplable track guide unit (111) of a rail vehicle, in particular a road-rail vehicle, according to one embodiment of the invention. The track guide unit (111) can be displaced between a raised and lowered position by means of a drive (102). In FIG. 21a, the track guidance unit (111) is shown in the lowered position in the coupled state. A rod-shaped permanent magnet (131) is located inside the track guidance unit (111). A coil acting as an electromagnet (132) is angled here around the outside of the track guidance unit (111) and can be connected to a switch, not shown here, to an actuator, also not shown, so that a current can be energised by the windings of the coil both in a first direction and in a second direction opposite to the first direction. Thus, the electromagnet (132) is suitable for exerting a magnetic field that can both strengthen and weaken the magnetic coupling of the track guide unit (111) with the track/rail/track guide (121). In order to efficiently decouple the track guide unit (111) from the track/rail (121), the field (135) emanating from the permanent magnet (131) can first be weakened using the coil before the drive (102) lifts the track guide unit (111) until the distance is large enough and the magnetic field lines (135) no longer penetrate the rail material, as shown in FIG. 21b. Preferably, the track guide unit (111) can be raised for travelling on the road to such an extent that it does not extend beyond the vehicle floor (105).

FIG. 22 shows a third track guide unit (111) of a rail vehicle, in particular a road-rail vehicle, according to one embodiment of the invention, which is coupled to the track/rail (121) via a permanent magnet (131). A drive, not shown here, is suitable for displacing the track guide unit (111) between a lowered position and a raised position via a toothed wheel (141). The vehicle floor (105) has a receiving space (106) that can accommodate the entire lane guidance unit (111) in the raised position, so that all safety distances in road traffic continue to be maintained. Preferably, the permanent magnet (131) in this configuration is switchable in a similar way to FIG. 20 and is field-free towards the outside in the raised position. In this way, unwanted interactions with the environment are avoided.

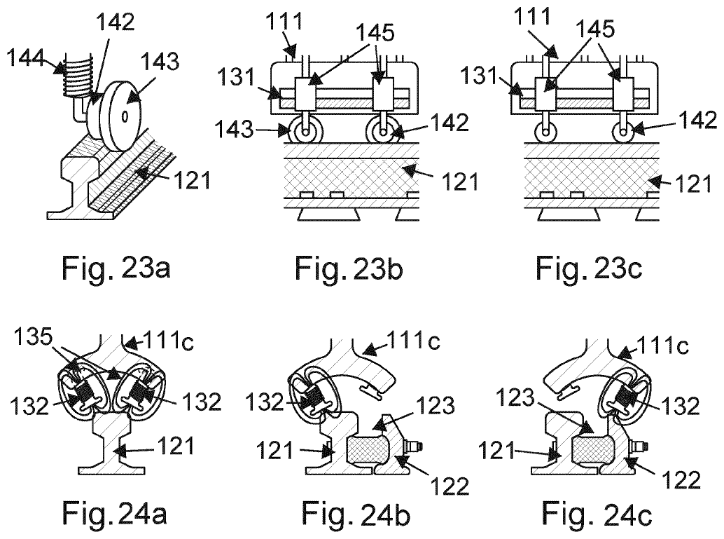

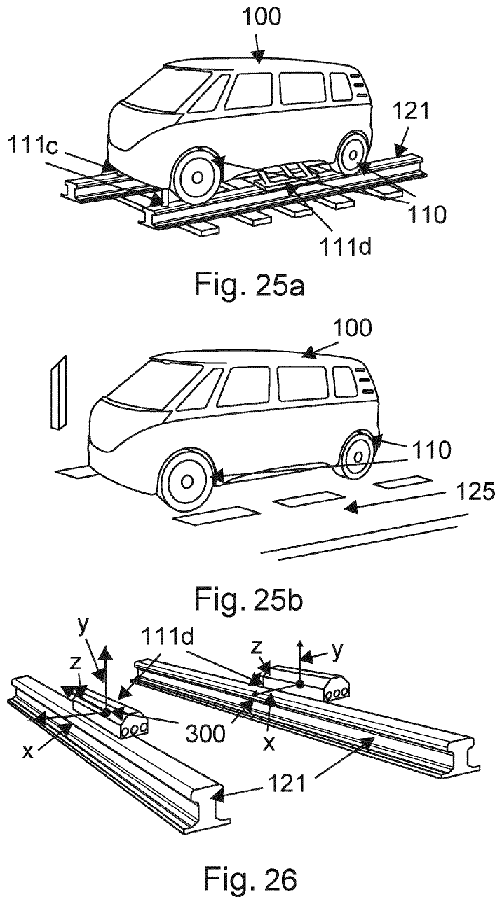

FIG. 23 shows a track guide unit (111) of a rail vehicle, in particular a road-rail vehicle, according to one embodiment of the invention, which can be coupled to the track/rail (121) both mechanically via rollers (142) and magnetically via a permanent magnet (131) embedded in the track guide unit (111). The magnetic support is shown here to emphasise how a combination of magnetic and mechanical coupling can look. However, individual track guide units can also be designed purely mechanically. For example, they can be connected via the rollers shown or via clothes brushes or similar mechanical coupling methods known to the skilled person for track/rail/track guidance. The roller (142) of the track guide unit (111) rests here on the rail (121) from above and serves to regulate the distance between the magnetic part of the track guide unit (111) and the track/rail (121) and, in particular, prevents the distance from becoming too small. It is also conceivable to achieve a mechanical coupling via rollers resting against the sides of the rails. For example, these rollers can contact a rail from both sides and hold the vehicle on the rail. Individual track guidance units can be coupled exclusively mechanically to the rails. A wheel rim (143) can additionally fix the track guidance unit (111) to the track/rail (121), as shown in FIG. 23a. The track guidance unit (111) can have a spring (144) and/or a damping element (145) and be connected to the vehicle via this. The rollers (142) are preferably rigidly connected to the permanent magnet (131) so that a certain minimum distance of, for example, 5 mm between the track guide unit (111), in particular the permanent magnet (131), and the track/rail (121) is maintained. In this way, good contact of the rollers (142) with the track/rail (121) is ensured and an unbalanced attraction of the vehicle to the track/rail (121) is prevented. FIG. 23b shows a side view of the track guide unit (111). To simplify lane changing operations at a turnout (123) against its current orientation, it is advantageous to dispense with the wheel rim (143), as shown in FIG. 23c. This design is suitable for rolling over a switch (123), as the roller (142) only rests on the top and has no lateral contact with the track/rail (121), which could otherwise tilt with another track/rail. This track guide unit (111) is particularly suitable as a track guide unit (111d) (see FIG. 25a) for fixing on a rail.

FIG. 24 shows a magnetically couplable track guidance unit (111c) of a rail vehicle, in particular a road-rail vehicle, for control on a track/rail (121) according to one embodiment of the invention. However, it is also possible to transfer this concept to track guidance units for fixation. The track guide unit (111c) has two electromagnets (132) arranged in a V-shape, which can be activated individually by means of an actuator and which can be moved between a lowered and a raised position by means of a drive. FIG. 24a shows the track guide unit (111c) in a coupled state with a single track/rail (121). The magnetic attraction force of both electromagnets (132) is equalised here in the horizontal direction. FIGS. 24b and 24c show a second track/rail/track guide (122) of a switch (123) at which the vehicle must choose from two tracks. By exclusively coupling the left electromagnet (132) with the track/rail (121), the vehicle follows the left track, as shown in FIG. 24b. For this purpose, it is advantageous if the track guide unit (111) can be displaced horizontally by a transverse offset. In a similar way, the track guidance unit (111) is displaced in the other direction by a transverse offset and coupled to the right-hand track (122) by activating the right-hand electromagnet (132). The track guidance unit (111c) is connected to a front wheel of the vehicle or mounted in the vicinity of the front wheel and forces the vehicle to follow the respective desired track/rail (121, 122) due to the coupling of the track guidance unit (111c) with the track/rail/track guide (121, 122).

FIG. 25 shows a road-rail vehicle (100) according to one embodiment of the invention. The road-rail vehicle (100) has a chassis set up for a track/rail/track guide (121), on which at least two axles are each mounted with wheels (110), and with several track guide units (111), which can be individually coupled to the track/rail/track guide (121) independently of one another via at least one drive and/or actuator of the road-rail vehicle (100) (rail vehicle). The tracked-in state is shown in FIG. 25a. The track guide unit (111c) located in front of the front axle is used for steering on the track/rail (121), while the track guide unit (111d) located between the axles is used for fixing the road-rail vehicle (100) on the track/rail. Here and in the following drawings, the track guidance units can be all of the coupleable track guidance units shown and described in FIG. 20 to FIG. 24. Individual track guidance units can also be connected exclusively mechanically. The magnetic coupling does not exclude an additional mechanical coupling of the track guidance unit, and vice versa. In a suitable section, for example at a level crossing, the track guidance units (111) are optionally decoupled using the actuator and raised using the drive, with the track guidance units (111) preferably being accommodated in their entirety in the vehicle floor for travelling on the road (125), as shown in FIG. 25b. In the case of the track guide units (111d) for fixing, it is advantageous if these are elongated in the direction of travel in order to increase the coupling strength. One such track guide unit (111d) is shown in isolation in FIG. 26. Its cross-section and coupling and switching behaviour have already been described in FIG. 20. This switchable track guide unit (111d) simplifies decoupling from the track/rail/track guides (121) and provides a sufficiently strong magnetic coupling. A Cartesian coordinate system (300) shown in FIG. 26 serves to explain the direction of movement (z-axis) of the vehicle, the displacement direction of the track guidance units (111) for decoupling (y-axis) and the displacement direction (transverse direction) of the track guidance units (111) for steering (x-axis).

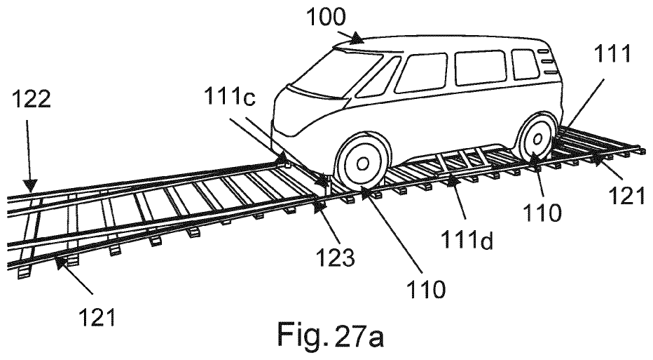

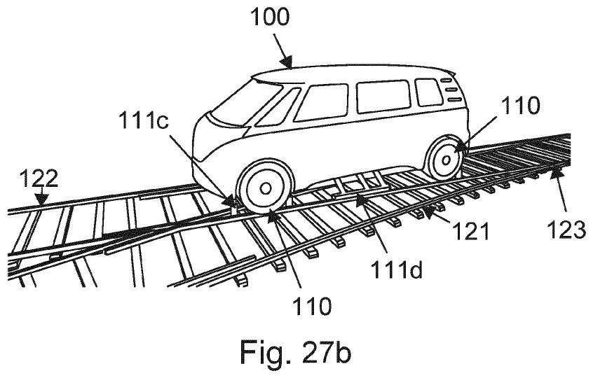

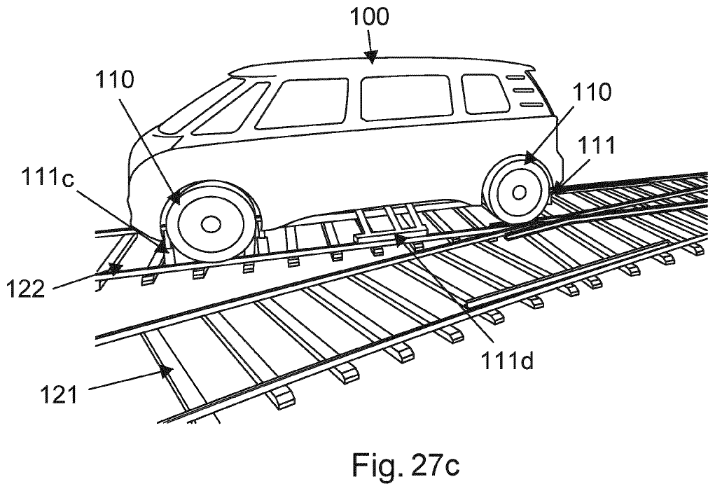

A crossing process of a two-way vehicle (100) according to one embodiment of the invention with track guide units (111d) for fixing and track guide units (111c) for controlling at a switch (123) is shown in FIG. 27a to FIG. 27c. The track is divided at the points (123) into a track/rail/track guide (122) leading straight ahead and a track/rail/track guide (121) turning left from the direction of travel of the vehicle, with the points (123) being aligned for “turning” in the present case. In FIG. 27a, for example, the switch (123) is detected by means of a sensor system and the driver/vehicle/on-board computer is offered a choice of which lane (121, 122) is to be followed. Preferably, the track guidance units (111c) arranged in front of the front axle (bow side) are coupled purely magnetically to the track/rail (121) for control purposes. The track guidance units (111c) for control can of course generally be mechanically supported or even exclusively mechanically coupled to the track/rail (121). This can offer the aforementioned advantages in the control of the track guidance units (111c). The driver/vehicle/on-board computer decides to drive over the switch (123) against its direction and follow the lane (122) leading straight ahead. For this purpose, the lane guidance units (111c) are shifted to the right (in the x-direction) for control from the driver's perspective, so that the front tyres (110) connected to the lane guidance units (111c) roll over the small gap of the turnout (123) as the vehicle continues its journey. When the track guide units (111c) are moved to the control unit, the track guide units (111c) are decoupled from the first track/rail/track guide (121) and coupled to the second track/rail/track guide (122). The track guide units (111d) for fixing are designed here in the manner shown in FIG. 20 and FIG. 26 and can be switched/activated via an actuator. During the crossing process, those track guide units (111) that are mechanically coupled to the track/rail/track guide (121) other than by rollers resting on them from above are lifted one after the other in order to avoid tilting at the points (123). To make it easier to decouple the track guide unit (111d) from the first track (121) to fix the vehicle (100) on the track/rail and couple it to the desired track (122), it is first switched using the actuator (state as in FIG. 20b) so that it is field-free towards the outside. However, to simplify the control of the track guidance units (111d) and the control system in general, it is possible to leave the magnet “switched on” during the crossing of the turnout (123) and only deactivate it when uncoupling from the rails to continue travelling on the road. The vehicle (100) then drives over the points (123) and activates the magnet again (state as in FIG. 20a), so that the magnetic coupling is strong enough to fix the vehicle on the track/rail/track guide (122), as shown in FIG. 27b. When travelling over the track crossing of the right rail of the first track guide (121) with the left rail of the second track guide (122), the track guide unit (111d) can now remain activated for fixing without the risk of the vehicle (100) slipping/derailing due to an excessively strong magnetic coupling with an undesired track. Mechanically coupled track guide units (111) on the left-hand side of the vehicle from the driver's point of view, which are not mechanically coupled to the track/rail/track guide (121) exclusively via rollers resting from above, are raised for this purpose, provided that they have been mechanically coupled to the rail again in this section. However, it may be advantageous to keep these track guide units in a raised position until the vehicle (100) has completely passed over the switch area, i.e. behind the track crossing. In FIG. 27c, the track guide units (111c, 111d) are already coupled to the new track/rail/track guide (122) and the vehicle (100) has rolled over the points (123) with both axles. The rearmost track guide unit (111), which has been mechanically coupled here to the track/rail/track guide (121), is still shown here in a raised position and is lowered as soon as the vehicle (100) has left the switch area.

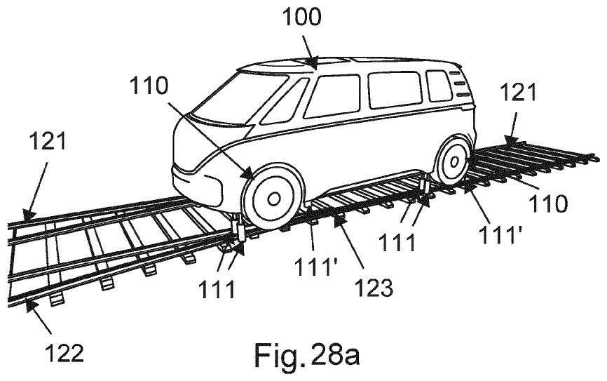

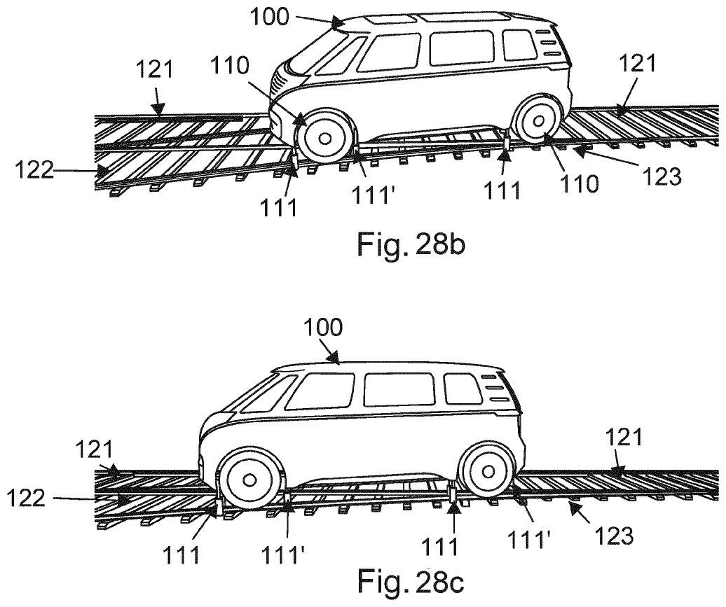

The road-rail vehicle (100) shown in FIG. 28 is fixed to the rail by a large number of track guidance units (111, 111′). Here, the vehicle has two magnetically and/or mechanically couplable track guide units (111) in front of the front axle and the rear axle (on the nose side in each case). The mechanical coupling can be achieved, for example, as shown here by rollers resting against the sides of the rails. Behind the front and rear axles there are in each case couplable track guide units (111′), which are raised for the duration of the crossing of the switch (123). The track guide units (111, 111′) on the front axle are connected to the front wheel or front axle (or arranged in the vicinity thereof) and guide the wheels (110) along the track/rail/track guide (121), while the track guide units (111, 111′) on the rear axle serve to improve the hold (fixation) of the vehicle (100) on the track/rail/track guide (121). In the context of FIG. 28, the front track guidance unit (111) is understood to be a track guidance unit (111) located in front of the respective axle and the rear track guidance unit (111′) is understood to be a track guidance unit (111′) located behind the respective axle. The two magnetically couplable track guidance units (111) in front of the axle can also be combined in the manner of the track guidance unit (111c) in FIG. 24 to form a common track guidance unit and are each individually vertically displaceable here and are magnetically coupled from the side to the respective rail. If the vehicle (100) (for example by means of a sensor) or the driver/vehicle/board computer registers during the journey that there is a turnout (123) in front of it, it makes a decision as before as to which track should be followed. Initially, all track guidance units (111, 111′) are “down” in the coupled state with the first track/rail/track guidance (121). The track guide units (111) located in front of the axle can also be mechanically coupled to the track/rail/track guide (121) so that the distance between the track guide units (111) and the rail does not fall below a certain level. If the left-hand track/rail/track guide (122) is now to be followed at the switch (123), but the switch (123) is aligned for straight-ahead travel, the right-hand track guide unit (111) located in front of the left-hand front wheel is lifted (i.e. moved upwards), while the left-hand track guide unit (111) remains magnetically and mechanically coupled to the track/rail/track guide (121, 122). Subsequently, the right track guide unit (111) in front of the left front wheel immediately behind the separation of the various track/rail/track guides (121, 122) (switch (123)) is shifted downwards again and coupled with the desired track/rail/track guide (122) and the track guide units (111′) located behind the front axle are raised and lowered again immediately after passing over the switch (123). Due to the asymmetry of the right and left rails at the points (123), the right and left track guide units in front of the right front wheel (not shown in the illustration) are raised and lowered in a similar manner with a time delay. In order to prevent the rail from tilting due to the air gap between the current track/rail/track guide (121) and the desired track/rail/track guide (122) located in front of the right front wheel, the left track guide unit is shifted to the left in front of the right front wheel. This process is then repeated on the rear axle when passing over the points (123) in the same form on the right and left corresponding to the behaviour of the track guidance units on the front axle. In FIG. 28a, the crossing process has already been completed for the track guidance units (111) mounted in front of the front axle, while the process for the track guidance units (111′) mounted behind the front axle is currently being carried out, i.e. the track guidance unit (111′) is raised and will be lowered and coupled to the track (122) after crossing the switch point (123), which is set to straight ahead. At the rear axle, the crossing process is still pending. FIG. 28b shows that on the rear axle, only the left track guidance unit (111) in front of the axle is connected to the desired track/rail/track guidance (122), while the right track guidance unit (111) attached to the rear axle (of the left wheel (110)) and the track guidance unit (111′) located behind the axle are in a raised position. FIG. 28c shows that on the rear axle, the right-hand track guidance unit (111) in front of the axle immediately behind the switch (123) is immediately lowered again in order to increase the grip of the vehicle (100) on the rail. Due to the proximity to the switch (123), the track guidance unit (111′) behind the rear axle is still in the raised state here and is only lowered when the vehicle (100) has left the area of the switch (123) behind it. On the right-hand side of the vehicle (100), the track guide units (111, 111′) must be raised and lowered in the same way, in particular at a later point in time when the right-hand rail of the track/rail/track guide (122) turning to the left and the left-hand rail of the track/rail/track guide (121) leading straight ahead cross in order to prevent the track guide units (111, 111′) and the vehicle (100) from tilting and being damaged.

There is further provided a two-way wheel (400), in particular for use in a two-way vehicle, which is suitable for travelling on different surfaces.

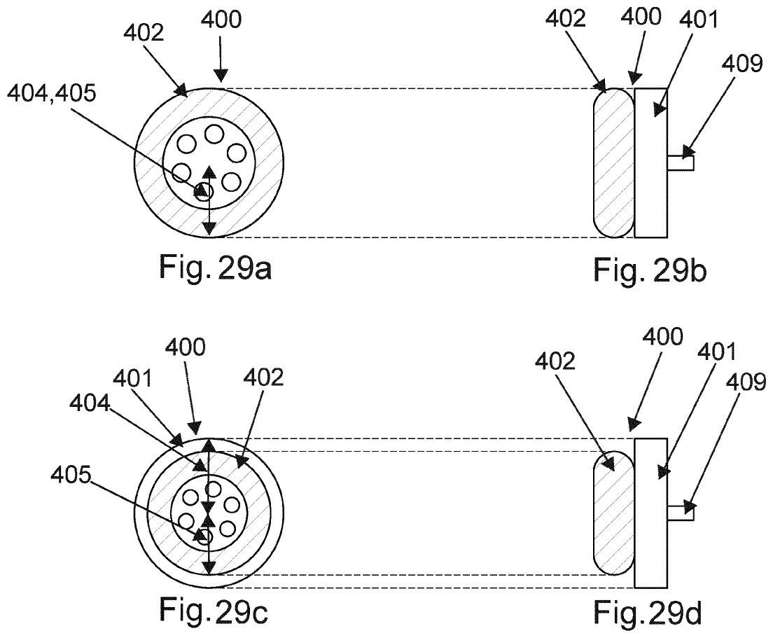

FIG. 29a shows a two-way wheel (400) in a side view. FIG. 29b shows a front view of the two-way wheel 110. It can be seen that the two-way wheel (400) is designed as a twin wheel and has a rubber-tyred wheel (402) and a hard wheel (401). The running surface (406) of the hard wheel (401) is smooth without curvature, while the rubber wheel (402) has an air tube and is conical in shape. The radii 404 and 405 are initially the same in FIG. 29a and FIG. 29b. FIG. 29c shows the two-way wheel (110) in a second state. In this case, the ratio of the radii 404 and 405 of the rubber wheel (402) and the hard wheel (401) to each other has been changed. In this case, the hard wheel (401) has a larger radius 404 than the rubber wheel (402). The smooth design of the running surface (403) of the hard wheel (401), in particular the absence of a wheel rim, enables the two-way wheel (400) to rest on hard smooth surfaces only from above and has no contact with the outer surface, for example of a rail. This makes the two-way wheel (400) suitable for travelling over rails/tracks/switches regardless of their alignment. The hard wheel (401) is narrower than the rubber wheel (402) in order to save weight. It is particularly preferable that only the rubber wheel (402) is used for travelling on the road due to a smaller radius 404 of the hard wheel (401) compared to the radius 405 of the rubber wheel (402), so that kerbs and potholes as well as other unevenness can be cushioned and only the rubber wheel (402) has contact with the ground, and that for travelling on rails only the hard wheel (401) has contact with the rail due to a larger radius 404 of the hard wheel (401) compared to the radius 405 of the rubber wheel (402).

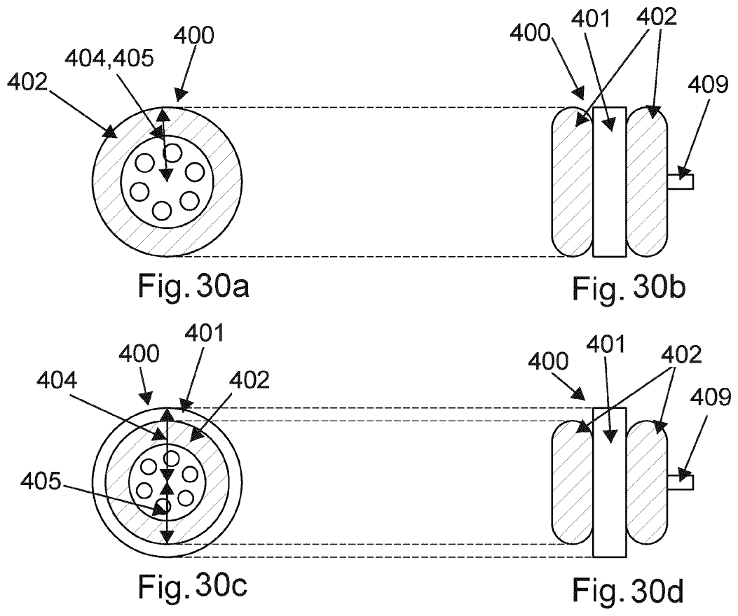

FIG. 30a and FIG. 30b show a two-way wheel (400), each in a side and front view. The two-way wheel (400) shown here is designed in the manner of a triplet wheel, in which the centre wheel is formed by a hard wheel (401) and the two other wheels are formed by rubber wheels (402). The hard wheel (401) is also narrower here than the rubber wheels (402). The design of the two-way wheel (400) as a triplet wheel enables the two-way wheel (400) to also be used for heavy transport, in which the weight must be distributed over several rubber wheels (402). The radii 404 and 405 of the rubber wheels (402) and the hard wheel (401) are initially identical. The ratio of the radii 404 and 405 to each other can be changed by means of a radius-changing mechanism not shown in detail here. FIG. 30c and FIG. 30d show the state of the two-way wheel (400) in a side and front view after actuation of the radius-changing mechanism. The ratio of the radii 404 and 405 to each other has been adjusted by the mechanism so that the hard wheel (401) now has a larger radius 404 than the rubber wheel (402). When travelling on the rail, the rubber wheels (402) would therefore have no contact with the ground and are not in the way, especially when driving over rails/tracks/switches.

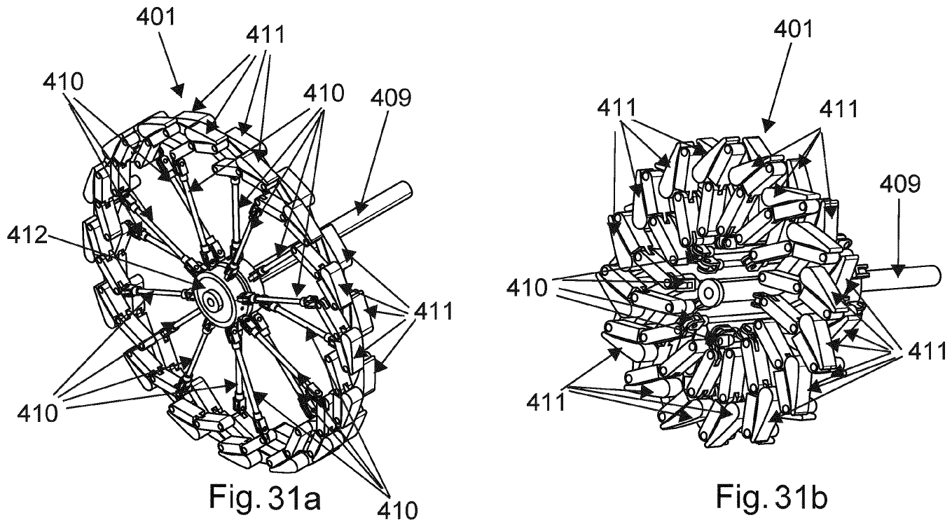

FIG. 31a and FIG. 31b show a hard wheel (401) with an exemplary radius-changing mechanism. The hard wheel (401) has spokes (410), which are connected to tread segments (411) via a plurality of joints. The spokes (410) are connected in the centre to form a hub (412) which is displaceably mounted on an axle (409). The spokes (410) are rotatably mounted both on the tread segments (411) and on the hub (412). In the extended state of the hard wheel (401), as shown in FIG. 31a, the tread segments (411) form approximately a closed circle from a sufficiently large number of tread segments (411), so that no jerking is noticeable for a driver of a two-way vehicle using a two-way wheel whose hard wheel can be changed in its radius by means of this mechanism when travelling on rails. In order to reduce the radius of the hard wheel (401), the hub (412) is moved along the axle (409), for example with the aid of a hydraulic or pneumatic working cylinder not shown here, so that the ends of the spokes (410) connected to the tread segments (411) are pulled radially inwards or pushed outwards. In FIG. 31b, the hard wheel (401) is shown in the retracted state. In a preferred alternative, which is not shown here, the spokes (410) themselves are formed by hydraulic or pneumatic working cylinders and are stretched or retracted via the pressurisation in order to vary the radius 404 of the hard wheel (401). This alternative is particularly favoured when the two-way wheel (400) is formed as a triplet wheel, as the wheel hub (412) cannot simply be pushed along the axle (409) in this case. The design of the hard wheel (401) with spokes (410) compared to conventional conical rail wheels or rail wheels with wheel rim, which are generally designed as solid wheels, offers the advantage that the hard wheel (401) is particularly light. This is possible because the two-way wheels (400) are preferably used for two-way vehicles, such as those shown in FIG. 1 to FIG. 19 and FIG. 25 to FIG. 28, which have a significantly reduced weight compared to most rail vehicles. It is particularly preferred that the radius 404 of the hard wheel (401) in the first state in FIG. 31a is large enough, in particular larger than the radius 405 of the rubber wheel(s) (402), to prevent contact of the rubber wheel(s) (402) with the ground or rails when a road-rail vehicle is travelling on rails. It is also preferred that the radius 404 of the hard wheel (401) in the second state in FIG. 31b is small enough, in particular smaller than the radius 405 of the rubber wheel(s) (402), to prevent contact of the hard wheel (401) with the ground/road.

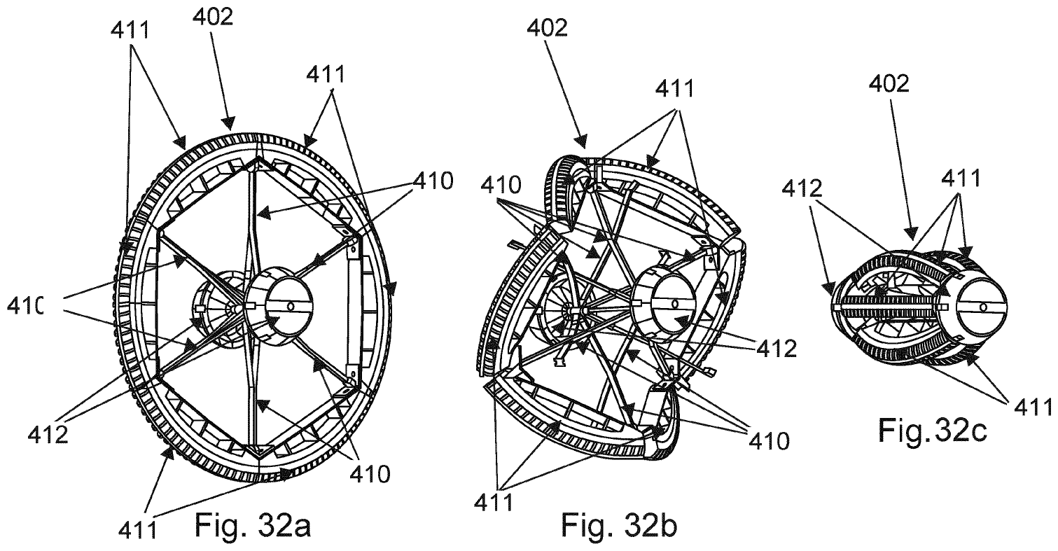

FIG. 32a to FIG. 32c show a further design of a radius-changing mechanism. Here, the radius of a rubber wheel (402) is changed by folding tread segments (411) alternately forwards and backwards by means of spokes (410) to form two hubs (412), the distance between which can be varied, for example by means of a working cylinder. This design is particularly preferable if the rubber wheel (402) is not equipped with an air hose and is part of a twin wheel as shown in FIG. 29, so that the hub (412) facing away from the hard wheel (401) can be easily extended when activated if a change is to be made from a journey with rubber wheels (402) to a journey with hard wheels (401).

The embodiments shown here are only examples of the present invention and should therefore not be understood to be limiting. Alternative embodiments contemplated by the skilled person are equally encompassed by the scope of protection of the present invention.

### LIST OF REFERENCE SYMBOLS

100 Track/rail-coupled (two-way) vehicle
101 Chassis
102 Drive
103 Sensor technology/sensors, e.g. position sensors and/or measuring units
104 Control/regulation unit
105 Vehicle floor
106 Receiving space
110 Wheel
111 Track guidance unit
111′ More guidance units
111a Front track guidance unit
111b Rear track guidance unit
111c Track guidance unit for control
111d Track guide unit for fixing on a rail
R1, R2, R3, R4 Right-hand track guidance units (two wheel axles, four wheels)
L1a, L3a, R1a, R3a Additional front or rear redundant track guidance units
Xa First longitudinal section of the track/rail
Xb Second longitudinal section of the track/rail
x3 Turning point of a turnout
112 Hydraulic ram
113 Support roller
114 Wheel flange or guide flange
115 Spring
116 Damping element
121 Track/rail/track guide
122 Second track/rail/track guide
123 Switch
125 Road
131 Permanent magnet
131′ Cylindrical magnet
132 Electromagnet
133 North Pole
134 South Pole
135 Magnetic field
140 Gear wheel for connecting a magnet to an actuator
141 Gear wheel for displacing a track guidance unit
142 Roller
143 Wheel rim
144 Spring
145 Damping element
199 Track change kinematics, acting at the front and rear of a respective axle
200 System with track-bound vehicle and track/rail/track guides
300 Cartesian coordinate system
400 Two-way wheel
401 Hard wheel
402 Rubber tyred wheel
404 First radius
405 Second radius
409 Axle
410 Spoke
411 Tread segment
412 Hub

1-33. (canceled)

34. A method for operating a railway vehicle, in particular a road-rail vehicle with a chassis set up for track/rail/track guidance, on which at least two axles are each mounted with wheels, the method comprising:
providing a plurality of track guidance units which can be individually coupled to the track/rail/track guide independently of one another via at least one drive and/or actuator of the rail vehicle, and the individual track guidance units can be individually displaced and/or activated independently of one another in this way, that the rail vehicle can be decoupled from a first track/rail/track guide during a journey, in particular at a minimum speed of 10 km/h, for a track change in the region of a switch along the track/rail/track guide and can be coupled to a second track/rail/track guide;
whereby a lane change can be carried out during the journey by means of a control/regulation unit based on measured values from a sensor system of the rail vehicle;
wherein the rail vehicle has the sensor system, in particular on an underside of the rail vehicle, for detecting the track or rail, in particular the switch, in particular a relative position between the rail vehicle and the switch and/or an alignment of the switch;
wherein the sensor system comprises a position sensor and/or a measuring unit;
wherein a relative position between the rail vehicle and the switch can be detected based on measurement data from the sensor system and/or geoposition data and/or in conjunction with/by means of at least one marking or detection transmitter of a switch or control unit and/or on the basis of time and speed data of the rail vehicle;
wherein a control/regulation unit carries out a lane change in the region of the switch in accordance with a desired direction of travel and against the switch position in the event of a deviation between the desired direction of travel and the direction of travel predetermined by the switch position during a journey;
wherein the vehicle does not travel slower than 10 km/h when changing lanes, wherein the rail vehicle is decoupled from the first track/rail/track guide and coupled to the second track/rail/track guide; and
wherein the relative position between the rail vehicle and the switch is detected by a detection device of the rail vehicle, wherein information about a desired direction of travel is received by a receiver unit of the rail vehicle and stored by a memory unit of the rail vehicle, wherein an evaluation unit carries out a comparison between the direction of travel specified by the switch position and the desired direction of travel.

35. The method according to claim 34, wherein for decoupling from the first track/rail/track guide and for coupling to the second track/rail/track guide at least one first track guide unit on a bow side of the corresponding axle and at least one second track guide unit on a rear side of the corresponding axle can be displaced individually vertically and optionally also individually horizontally in a lateral direction transverse to the rail vehicle, wherein the respective track guide unit at a front and rear are/are arranged in different transverse and/or height positions, and wherein the height position of either one/the currently unloaded track guide unit is shifted downwards until this track guide unit ensures support and guidance of the rail vehicle on the desired track/rail/track section, so that the rail vehicle is coupled thereto, whereupon the height position of the other track guide unit is raised, so that the rail vehicle is decoupled from the previous track/rail/track guide, the respective track guide units being actuated/controlled by means of the control/regulation unit on the basis of measurement data from a sensor system of the rail vehicle.

36. The method according to claim 34, wherein for decoupling from the first track/rail/track guide and for coupling to the second track/rail/track guide for a track change in the region of a switch, at least two track guide units can each be displaced individually vertically, optionally also individually horizontally, on one side of the rail vehicle in a lateral direction transversely to the rail vehicle and/or wherein a magnetic coupling is generated/reinforced via activation of magnets a magnetic coupling is generated/amplified, wherein the respective track guidance unit is/is arranged in different transverse and/or height positions and/or a magnet of a track guidance unit located at a predefined distance from the track/rail/track guide is deactivated and/or activated, wherein the respective track guidance units are actuated/controlled based on measurement data from a sensor system of the rail vehicle by means of the control/regulation unit.

37. The method according to claim 34, wherein a time of activation of a permanent magnet or electromagnet and/or the height displacement and optionally also a transverse displacement of the track guide units is defined as a function of an instantaneous position of the rail vehicle on the track/rail/track guide, in particular in that the time is specified by means of the control/regulation unit to at least one drive and/or actuator of the rail vehicle in the region of the switch.
